(19) United States
(12) Patent Application Publication
(10) Pub. No.: US 2024/0287349 A1
(43) Pub. Date: Aug. 29, 2024

(54) WATER-CURABLE SILICONE COMPOSITIONS AND RELATED METHODS

(71) Applicant: BMIC LLC, Dallas, TX (US)

(72) Inventors: Andrew Andrade, Hackensack, NJ (US); Yan Zheng, Dallas, TX (US); Yixi Xiao, Dallas, TX (US); Joshua Tingley, Morris Plains, NJ (US)

(21) Appl. No.: 18/585,922

(22) Filed: Feb. 23, 2024

Related U.S. Application Data
(60) Provisional application No. 63/486,897, filed on Feb. 24, 2023.

(51) Int. Cl. C09D 183/04; B01J 37/10; C09D 7/61; C09D 7/63

(52) U.S. Cl. CPC C09D 183/04; B01J 37/10; C09D 7/61; C09D 7/63

(57) ABSTRACT

Silicone compositions and related methods are provided. A silicone composition comprises a polysiloxane, a crosslinker, a water-activated catalyst, a water-release agent, and a filler. When subjected to an external stimulus, the water-release agent supplies sufficient water for activating the water-activated catalyst. A method of installation comprises one or more of the following steps: obtaining a silicone composition, applying the silicone composition to at least one surface of a substrate, heating the water-curable silicone composition, and curing the silicone composition.

### CROSS-REFERENCE TO RELATED APPLICATIONS

The present application claims priority to and benefit of U.S. Provisional Patent Application No. 63/486,897, filed Feb. 24, 2023 and entitled “WATER-CURABLE SILICONE COMPOSITIONS AND RELATED METHODS,” the entirety of which is herein incorporated by reference.

### FIELD

This disclosure generally relates to water-curable silicone compositions and related methods.

### BACKGROUND

Some coating compositions are applied as liquids and hardened via curing. To cure the coating compositions, an external stimulus is supplied to the coating composition to induce the curing.

### SUMMARY

Some embodiments relate to a method of installation. In some embodiments, the method of installation comprises obtaining a water-curable silicone composition. In some embodiments, the water-curable silicone composition comprises a silanol-terminated polysiloxane. In some embodiments, the water-curable silicone composition comprises a crosslinker. In some embodiments, the water-curable silicone composition comprises a water-activated catalyst. In some embodiments, the water-curable silicone composition comprises 1% to 40% by weight of a heat-activated water-release agent based on a total weight of the water-curable silicone composition. In some embodiments, the method of installation comprises applying the water-curable silicone composition to at least one surface of a building structure. In some embodiments, the method of installation comprises heating the water-curable silicone composition to a temperature of 250° C. or less, so as to obtain a water from the heat-activated water-release agent. In some embodiments, the water obtained from the heat-activated water-release agent activates the water-activated catalyst. In some embodiments, the method of installation comprises curing the water-curable silicone composition, so as to obtain a water-cured silicone composition.

In some embodiments, the water-curable silicone composition is heated to a temperature of 20° C. to 250° C.

In some embodiments, the heating decomposes the heat-activated water-release agent, so as to obtain the water.

In some embodiments, the heating disassociates water molecules from the heat-activated water-release agent, so as to obtain the water.

In some embodiments, the curing comprises reacting the silanol-terminated polysiloxane and the crosslinker in a presence of the water-activated catalyst.

In some embodiments, the water-curable silicone composition further comprises at least one filler. In some embodiments, the at least one filler is different from the heat-activated water-release agent.

In some embodiments, the water-curable silicone composition comprises 10% to 80% by weight of the silanol-terminated polysiloxane based on the total weight of the water-curable silicone composition. In some embodiments, the water-curable silicone composition comprises 1% to 30% by weight of the crosslinker based on the total weight of the water-curable silicone composition. In some embodiments, the water-curable silicone composition comprises 0.1% to 20% by weight of the water-activated catalyst based on the total weight of the water-curable silicone composition. In some embodiments, the water-curable silicone composition comprises 1% to 50% by weight of at least one filler based on the total weight of the water-curable silicone composition.

In some embodiments, the water-curable silicone composition comprises 1% to 30% by weight of the heat-activated water-release agent based on the total weight of the water-curable silicone composition.

In some embodiments, the heat-activated water-release agent comprises at least one of an inorganic hydrate compound, an organic hydrate compound, or any combination thereof.

In some embodiments, the heat-activated water-release agent comprises a compound that decomposes to produce the water in response to the heating.

Some embodiments relate to a water-curable silicone composition. In some embodiments, the water-curable silicone composition comprises a silanol-terminated polysiloxane. In some embodiments, the water-curable silicone composition comprises a crosslinker. In some embodiments, the water-curable silicone composition comprises a water-activated catalyst. In some embodiments, the water-curable silicone composition comprises a heat-activated water-release agent. In some embodiments, the heat-activated water-release agent is present in the water-curable silicone composition in an amount sufficient to obtain, in response to heating, a water for activating the water-activated catalyst. In some embodiments, the water-activated catalyst is selected from the group of catalysts for inducing, in a presence of the water obtained from the heat-activated water-release agent, curing of the water-curable silicone composition. In some embodiments, the heat-activated water-release agent comprises at least one of an inorganic hydrate compound, an organic hydrate compound, or any combination thereof.

In some embodiments, the water-curable silicone composition comprises 10% to 80% by weight of the silanol-terminated polysiloxane based on a total weight of the water-curable silicone composition.

In some embodiments, the water-curable silicone composition comprises 1% to 30% by weight of the crosslinker based on a total weight of the water-curable silicone composition.

In some embodiments, the water-curable silicone composition comprises 0.1% to 20% by weight of the water-activated catalyst based on a total weight of the water-curable silicone composition.

In some embodiments, the water-curable silicone composition comprises 1% to 40% by weight of the heat-activated water-release agent based on a total weight of the water-curable silicone composition.

In some embodiments, the water-curable silicone composition further comprises at least one filler.

In some embodiments, the at least one filler is different from the heat-activated water-release agent.

In some embodiments, the water-curable silicone composition comprises 1% to 50% by weight of the at least one filler based on a total weight of the water-curable silicone composition.

In some embodiments, the water-curable silicone composition comprises 10% to 80% by weight of the silanol-terminated polysiloxane based on a total weight of the water-curable silicone composition. In some embodiments, the water-curable silicone composition comprises 1% to 30% by weight of the crosslinker based on the total weight of the water-curable silicone composition. In some embodiments, the water-curable silicone composition comprises 0.1% to 20% by weight of the water-activated catalyst based on the total weight of the water-curable silicone composition. In some embodiments, the water-curable silicone composition comprises 1% to 50% by weight of at least one filler based on the total weight of the water-curable silicone composition.

In some embodiments, the heat-activated water-release agent comprises the inorganic hydrate compound.

In some embodiments, the heat-activated water-release agent comprises the organic hydrate compound.

### BRIEF DESCRIPTION OF THE DRAWINGS

Reference is made to the drawings that form a part of this disclosure, and which illustrate embodiments in which the materials and methods described herein can be practiced.

FIG. 1 is a flowchart of a method of installation, according to some embodiments.

### DETAILED DESCRIPTION

Some embodiments relate to silicone compositions and related methods. In some embodiments, the silicone compositions comprise a water-curable (or moisture-curable) silicone composition. In some embodiments, the water-curable silicone composition comprises an internal water source for curing the water-curable silicone composition. For example, in some embodiments, the water-curable silicone composition comprises a polysiloxane, a crosslinker, a heat-activated water-release agent, and a water-activated catalyst. In some embodiments, when heated to a specified temperature, the heat-activated water-release agent supplies sufficient water for activating the water-activated catalyst. In some embodiments, the water-curable silicone compositions are self-curable silicon compositions that do not require an external supply of water to induce crosslinking.

In some embodiments, the silicone composition comprises a polysiloxane.

As used herein, a “polysiloxane” is a polymer that includes at least two of the following repeat units: —R₂Si—O—SiR₂—, where R is an organic group, or hydrogen. As used herein, an “organic group” may encompass any organosilicon group, such as but not limited to a silanol group or an alkyl silyl group. In some embodiments, a polysiloxane may include ten or more of the aforementioned repeat units. In some embodiments, a polysiloxane may include hundreds of the aforementioned repeat units. In some embodiments, a polysiloxane may include thousands of the aforementioned repeat units. In some embodiments, a polysiloxane may include tens-of-thousands of the aforementioned repeat units. In some embodiments, a polysiloxane may include hundreds-of-thousands of the aforementioned repeat units. In some embodiments, a polysiloxane may include millions of the aforementioned repeat units. As used herein, a “polysiloxane” may also include any version of the aforementioned formula where at least one of the R groups is substituted with an organic group. In some embodiments, the polysiloxane is unsubstituted, such that all of the R groups may be the same. In some embodiments, the polysiloxane is substituted such that some of the R groups may be the same while others may differ from each other. In some embodiments, the polysiloxane is substituted such that all of the R groups are different. In some embodiments, the polysiloxane is substituted or “terminated” with an organic group at the end of a polymer chain.

In some embodiments, the polysiloxane comprises or is selected from the group consisting of a hydroxy terminated polysiloxane, a di-hydroxy terminated polysiloxane, a vinyl terminated polysiloxane, a di-vinyl terminated polysiloxane, a tri-methyl-silyl terminated polysiloxane, a mono-trimethoxy terminated polysiloxane, a silanol terminated polysiloxane, or any combination thereof.

In some embodiments, the polysiloxane comprises, or is selected from the group consisting of a hydroxy terminated polysiloxane, a di-hydroxy terminated polysiloxane, a vinyl terminated polysiloxane, a di-vinyl terminated polysiloxane, a tri-methyl-silyl terminated polysiloxane, or any combination thereof.

In some embodiments, the polysiloxane comprises or is selected from the group consisting of a mono-trimethoxy terminated polysiloxane, a silanol terminated polysiloxane, or any combination thereof.

In some embodiments, the polysiloxane comprises, consists, or consists essentially of a mono-trimethoxy terminated polysiloxane. In some embodiments, the polysiloxane comprises, consists, or consists essentially of a silanol terminated polysiloxane.

As used herein, a “silane” is any compound having the general formula SiₙR_{2n+2,} where R is hydrogen, an organic group, or any combination thereof. As used herein, a “silane” may also include any version of the aforementioned formula where at least one of the R groups is substituted with an organic group. In some embodiments, the silane is unsubstituted, such that all of the R groups may be the same. In some embodiments, the silane is substituted such that some of the R groups may be the same while others may differ from each other. In some embodiments, the silane is substituted such that all of the R groups are different. Examples of at least one substituent R group may include, but is not limited to at least one amino group (in the non-limiting case of an aminosilane) and at least one methoxy group (in the non-limiting case of a methoxysilane).

In some embodiments, a silane may also encompass a bipodal silane. As used herein, a “bipodal silane” is a silane having the general formula R₃Si—R—SiR₃.

In some embodiments, the at least one silane comprises or is selected from the group consisting of an associative silane, a non-associative silane, or any combination thereof. In some embodiments, the at least one silane comprises, consists, or consists essentially of an associative silane. In some embodiments, the at least one silane comprises, consists, or consists essentially of a non-associative silane.

As used herein, an “associative silane” is a silane having the general formula Si(R¹)ₙ(R²)ₙ₊₂; where each R¹ group is a crosslinkable functional group, such as but not limited to, an alkoxy group, acetoxy group, or an oxime group; and where at least one of the R² groups is a functional group that interacts with another R² group, interacts with another component in a silicone composition, or any combination thereof. In some embodiments, the interaction occurs by an interaction mechanism, such as but not limited to, hydrogen bonding, electrostatic attraction, π-π stacking, or any combination thereof.

As used herein a “non-associative silane” is any silane that is not an “associative silane.”

In some embodiments, the associative silane comprises or is selected from the group consisting of an epoxysilane, an aminosilane, a diphenylsilane, or any combination thereof.

In some embodiments, the associative silane comprises or is selected from the group consisting of methacryloxypropyltrimethoxysilane, mercaptopropyltrimethoxysilane methacryloxypropylmethyldimethoxysilane, diphenyldimethoxysilane, an epoxy silane oligomer, glycidoxypropyltrimethoxysilane, aminoethylaminopropyltrimethoxysilane, or any combination thereof.

In some embodiments, the associative silane comprises or is selected from the group consisting of methacryloxypropyltrimethoxysilane, mercaptopropyltrimethoxysilane methacryloxypropylmethyldimethoxysilane, diphenyldimethoxysilane, an epoxy silane oligomer, or any combination thereof.

In some embodiments, the associative silane comprises or is selected from the group consisting of glycidoxypropyltrimethoxysilane, aminoethylaminopropyltrimethoxysilane, or any combination thereof.

In some embodiments, the associative silane comprises, consists, or consists essentially of glycidoxypropyltrimethoxysilane.

In some embodiments, the associative silane comprises, consists, or consists essentially of aminoethylaminopropyltrimethoxysilane.

In some embodiments, the non-associative silane is octylsilane.

In some embodiments, the non-associative silane comprises or is selected from the group consisting of octyltrimethoxysilane, vinyltrimethoxysilane, or any combination thereof.

In some embodiments, the non-associative silane is vinyltrimethoxysilane.

In some embodiments, the non-associative silane is octyltrimethoxysilane.

In some embodiments, the silicone composition comprises at least one bipodal silane. Non-limiting examples of a bipodal silane include bis(trimethoxysilylpropyl)amine (commercially available as Andisil® 1170) and bis [3-(triethoxysilyl)propyl] tetrasulfide (commercially available as Andisil® 1289).

In some embodiments, the silicone composition does not comprise a bipodal silane.

In some embodiments, the silicone composition may exclude certain specific bipodal silanes. For instance, in some embodiments, the silicone composition does not comprise bis-(triethoxysilyl) ethane, bis(trimethoxysilylpropyl)amine, bis [3-(triethoxysilyl)propyl] tetrasulfide, or any combination thereof.

In some embodiments, the polysiloxane comprises a silanol-terminated polysiloxane. In some embodiments, the polysiloxane comprises a silanol-terminated polydimethylsiloxane.

Examples of hydroxyl-terminated polysiloxanes include, without limitation, Andisil® OH Polymers, such as, for example and without limitation, at least one of Andisil® OH 750 Silanol terminated 750 cps; Andisil® OH 1,000 Silanol terminated 1,000 cps; Andisil® OH 2,000 Silanol terminated 2,000 cps; Andisil® OH 3,500 Silanol terminated 3,500 cps;

Andisil® OH 4,000 Silanol terminated 4,000 cps; Andisil® OH 6,000 Silanol terminated 6,000 cps; Andisil® OH 14,000 Silanol terminated 14,000 cps; Andisil® OH 20,000 Silanol terminated 20,000 cps; Andisil® OH 50,000 Silanol terminated 50,000 cps; Andisil® OH 80,000 Silanol terminated 80,000 cps; Andisil® OH 300,000 Silanol terminated 300,000 cps; or any combination thereof.

In some embodiments, the silicone composition comprises 10% to 80% by weight of the polysiloxane based on a total weight of the silicone composition. In some embodiments, the silicone composition comprises 15% to 80% by weight of the polysiloxane based on the total weight of the silicone composition. In some embodiments, the silicone composition comprises 20% to 80% by weight of the polysiloxane based on the total weight of the silicone composition. In some embodiments, the silicone composition comprises 25% to 80% by weight of the polysiloxane based on the total weight of the silicone composition. In some embodiments, the silicone composition comprises 30% to 80% by weight of the polysiloxane based on the total weight of the silicone composition. In some embodiments, the silicone composition comprises 35% to 80% by weight of the polysiloxane based on the total weight of the silicone composition.

In some embodiments, the silicone composition comprises 40% to 80% by weight of the polysiloxane based on the total weight of the silicone composition. In some embodiments, the silicone composition comprises 45% to 80% by weight of the polysiloxane based on the total weight of the silicone composition. In some embodiments, the silicone composition comprises 50% to 80% by weight of the polysiloxane based on the total weight of the silicone composition. In some embodiments, the silicone composition comprises 55% to 80% by weight of the polysiloxane based on the total weight of the silicone composition. In some embodiments, the silicone composition comprises 60% to 80% by weight of the polysiloxane based on the total weight of the silicone composition. In some embodiments, the silicone composition comprises 65% to 80% by weight of the polysiloxane based on the total weight of the silicone composition. In some embodiments, the silicone composition comprises 70% to 80% by weight of the polysiloxane based on the total weight of the silicone composition. In some embodiments, the silicone composition comprises 75% to 80% by weight of the polysiloxane based on the total weight of the silicone composition.

In some embodiments, the silicone composition comprises 10% to 75% by weight of the polysiloxane based on the total weight of the silicone composition. In some embodiments, the silicone composition comprises 10% to 70% by weight of the polysiloxane based on the total weight of the silicone composition. In some embodiments, the silicone composition comprises 10% to 65% by weight of the polysiloxane based on the total weight of the silicone composition. In some embodiments, the silicone composition comprises 10% to 60% by weight of the polysiloxane based on the total weight of the silicone composition. In some embodiments, the silicone composition comprises 10% to 55% by weight of the polysiloxane based on the total weight of the silicone composition. In some embodiments, the silicone composition comprises 10% to 50% by weight of the polysiloxane based on the total weight of the silicone composition. In some embodiments, the silicone composition comprises 10% to 45% by weight of the polysiloxane based on the total weight of the silicone composition. In some embodiments, the silicone composition comprises 10% to 40% by weight of the polysiloxane based on the total weight of the silicone composition. In some embodiments, the silicone composition comprises 10% to 35% by weight of the polysiloxane based on the total weight of the silicone composition. In some embodiments, the silicone composition comprises 10% to 30% by weight of the polysiloxane based on the total weight of the silicone composition. In some embodiments, the silicone composition comprises 10% to 25% by weight of the polysiloxane based on the total weight of the silicone composition. In some embodiments, the silicone composition comprises 10% to 20% by weight of the polysiloxane based on the total weight of the silicone composition. In some embodiments, the silicone composition comprises 10% to 15% by weight of the polysiloxane based on the total weight of the silicone composition. In some embodiments, the silicone composition comprises 20% to 70% by weight of the polysiloxane based on the total weight of the silicone composition. In some embodiments, the silicone composition comprises 30% to 60% by weight of the polysiloxane based on the total weight of the silicone composition.

In some embodiments, the silicone composition comprises a crosslinker. As used herein, the term “crosslinker” refers to a compound capable of forming at least one linkage. In some embodiments, the linkage is a covalent bond. In some embodiments, the linkage is between different polysiloxanes. In some embodiments, the linkage is between the same polysiloxane. For example, in some embodiments, the linkage is between different regions of the same polysiloxane.

In some embodiments, the crosslinker comprises a neutral curing agent. In some embodiments, the crosslinker comprises at least one of ketoxime silanes, alkoxysilanes, acetoxysilanes, isopropenoxy silanes, a partial hydrolysate/condensate of said silanes, or any combination thereof. In some embodiments, the crosslinker comprises an organosilane, which may contain at least 2 or at least 3 hydrolyzable groups in one molecule and/or its partial hydrolysate. In some embodiments, a hydrolyzable group in such an organosilane or its partial hydrolysate includes at least one of a ketoxime group, an alkoxy group, an acetoxy group, an isopropenoxy group, or any combination thereof. In some embodiments, the crosslinker comprises ketoxime silanes. In some embodiments, a ketoxime silane comprises at least one of tetrakis(methylethylketoxime) silane, methyltris(dimethylketoxime) silane, methyltris(methylethylketoxime) silane, ethyltris(methylethylketoxime) silane, methyltris(methyl isobutyl ketoxime) silane, vinyl tris(methylethylketoxime) silane, vinyl tris(methylethylketoximino) silane, methyltris(methylethylketoximino) silane, or any combination thereof. In some embodiments, the crosslinker comprises an alkoxysilane. In some embodiments, the alkoxysilane comprises at least one of methyltrimethoxysilane, vinyltrimethoxysilane, phenyltrimethoxysilane, vinyltriethoxy silane, or any combination thereof. In some embodiments, the crosslinker comprises an acetoxysilane. In some embodiments, the acetoxysilane comprises at least one of methyltriacetoxysilane, vinyltriacetoxysilane, or any combination thereof. In some embodiments, the crosslinker comprises an isopropenoxy silane. In some embodiments, the isopropenoxy silane comprises at least one of methyltriisopropenoxysilane, vinyltriisopropenoxysilane, phenyltriisopropenoxysilane, or any combination thereof. In some embodiments, the crosslinker comprises a partial hydrolysate/condensate of any one of the silanes disclosed herein. In some embodiments, the crosslinker comprises at least one of methyltris(methylethylketoxime) silane, vinyltris(methylethylketoxime) silane, or any combination thereof.

In some embodiments, the silicone composition comprises 1% to 30% by weight of the crosslinker based on the total weight of the silicone composition. In some embodiments, the silicone composition comprises 2% to 30% by weight of the crosslinker based on the total weight of the silicone composition. In some embodiments, the silicone composition comprises 4% to 30% by weight of the crosslinker based on the total weight of the silicone composition. In some embodiments, the silicone composition comprises 6% to 30% by weight of the crosslinker based on the total weight of the silicone composition. In some embodiments, the silicone composition comprises 8% to 30% by weight of the crosslinker based on the total weight of the silicone composition. In some embodiments, the silicone composition comprises 10% to 30% by weight of the crosslinker based on the total weight of the silicone composition. In some embodiments, the silicone composition comprises 12% to 30% by weight of the crosslinker based on the total weight of the silicone composition. In some embodiments, the silicone composition comprises 14% to 30% by weight of the crosslinker based on the total weight of the silicone composition. In some embodiments, the silicone composition comprises 16% to 30% by weight of the crosslinker based on the total weight of the silicone composition. In some embodiments, the silicone composition comprises 18% to 30% by weight of the crosslinker based on the total weight of the silicone composition. In some embodiments, the silicone composition comprises 20% to 30% by weight of the crosslinker based on the total weight of the silicone composition. In some embodiments, the silicone composition comprises 22% to 30% by weight of the crosslinker based on the total weight of the silicone composition. In some embodiments, the silicone composition comprises 24% to 30% by weight of the crosslinker based on the total weight of the silicone composition. In some embodiments, the silicone composition comprises 26% to 30% by weight of the crosslinker based on the total weight of the silicone composition. In some embodiments, the silicone composition comprises 28% to 30% by weight of the crosslinker based on the total weight of the silicone composition.

In some embodiments, the silicone composition comprises 1% to 28% by weight of the crosslinker based on the total weight of the silicone composition. In some embodiments, the silicone composition comprises 1% to 26% by weight of the crosslinker based on the total weight of the silicone composition. In some embodiments, the silicone composition comprises 1% to 24% by weight of the crosslinker based on the total weight of the silicone composition. In some embodiments, the silicone composition comprises 1% to 22% by weight of the crosslinker based on the total weight of the silicone composition. In some embodiments, the silicone composition comprises 1% to 20% by weight of the crosslinker based on the total weight of the silicone composition. In some embodiments, the silicone composition comprises 1% to 18% by weight of the crosslinker based on the total weight of the silicone composition. In some embodiments, the silicone composition comprises 1% to 16% by weight of the crosslinker based on the total weight of the silicone composition. In some embodiments, the silicone composition comprises 1% to 15% by weight of the crosslinker based on the total weight of the silicone composition. In some embodiments, the silicone composition comprises 1% to 14% by weight of the crosslinker based on the total weight of the silicone composition. In some embodiments, the silicone composition comprises 1% to 13% by weight of the crosslinker based on the total weight of the silicone composition. In some embodiments, the silicone composition comprises 1% to 12% by weight of the crosslinker based on the total weight of the silicone composition. In some embodiments, the silicone composition comprises 1% to 11% by weight of the crosslinker based on the total weight of the silicone composition. In some embodiments, the silicone composition comprises 1% to 10% by weight of the crosslinker based on the total weight of the silicone composition. In some embodiments, the silicone composition comprises 1% to 9% by weight of the crosslinker based on the total weight of the silicone composition. In some embodiments, the silicone composition comprises 1% to 8% by weight of the crosslinker based on the total weight of the silicone composition. In some embodiments, the silicone composition comprises 1% to 7% by weight of the crosslinker based on the total weight of the silicone composition. In some embodiments, the silicone composition comprises 1% to 6% by weight of the crosslinker based on the total weight of the silicone composition. In some embodiments, the silicone composition comprises 1% to 5% by weight of the crosslinker based on the total weight of the silicone composition. In some embodiments, the silicone composition comprises 1% to 4% by weight of the crosslinker based on the total weight of the silicone composition. In some embodiments, the silicone composition comprises 1% to 3% by weight of the crosslinker based on the total weight of the silicone composition. In some embodiments, the silicone composition comprises 1% to 2% by weight of the crosslinker based on the total weight of the silicone composition.

In some embodiments, the silicone composition comprises a water-activated catalyst. As used herein, the term “water-activated catalyst” refers to a catalyst capable of increasing a reaction rate upon exposure to water.

In some embodiments, the water-activated catalyst is selected from the group of catalysts for inducing, in a presence of the water obtained from the heat-activated water-release agent, curing of the water-curable silicone composition. In some embodiments, the water-activated catalyst comprises at least one of triethanolamine titanate, triethanolamine titanate chelate, dimethyltin dioleate, dibutyltin diacetate, stannous octoate, dibutyltin dioctoate, dibutyltin dilaurate, dibutyltin dimethoxide, dibutyltin bis(acetylacetonate), dibutyltin bis(benzylmalate), dimethyltin dimethoxide, dimethyltin diacetate, dioctyltin dioctate, dioctyltin dilaurate, tin dioctate, tin laurate, tetraisopropyl titanate, tetra-n-butyl titanate, tetra-tertiary butyl titanate, tetra-n-propyl titanate, tetra-2-ethylhexyl titanate, diisopropyl di-tertiary butyl titanate, dimethoxy titanium bisacetylacetonate, diisopropoxy titanium bisethyl acetoacetate, di-tertiary butoxy titanium bisethyl acetoacetate, di-tertiary butoxy titanium bismethyl acetoacetate, or any combination thereof.

In some embodiments, the silicone composition comprises 0.1% to 20% by weight of the water-activated catalyst based on the total weight of the silicone composition. In some embodiments, the silicone composition comprises 0.5% to 20% by weight of the water-activated catalyst based on the total weight of the silicone composition. In some embodiments, the silicone composition comprises 1% to 20% by weight of the water-activated catalyst based on the total weight of the silicone composition. In some embodiments, the silicone composition comprises 1.5% to 20% by weight of the water-activated catalyst based on the total weight of the silicone composition. In some embodiments, the silicone composition comprises 2% to 20% by weight of the water-activated catalyst based on the total weight of the silicone composition. In some embodiments, the silicone composition comprises 2.5% to 20% by weight of the water-activated catalyst based on the total weight of the silicone composition. In some embodiments, the silicone composition comprises 3% to 20% by weight of the water-activated catalyst based on the total weight of the silicone composition. In some embodiments, the silicone composition comprises 3.5% to 20% by weight of the water-activated catalyst based on the total weight of the silicone composition. In some embodiments, the silicone composition comprises 4% to 20% by weight of the water-activated catalyst based on the total weight of the silicone composition. In some embodiments, the silicone composition comprises 4.5% to 20% by weight of the water-activated catalyst based on the total weight of the silicone composition. In some embodiments, the silicone composition comprises 5% to 20% by weight of the water-activated catalyst based on the total weight of the silicone composition.

In some embodiments, the silicone composition comprises 6% to 20% by weight of the water-activated catalyst based on the total weight of the silicone composition. In some embodiments, the silicone composition comprises 7% to 20% by weight of the water-activated catalyst based on the total weight of the silicone composition. In some embodiments, the silicone composition comprises 8% to 20% by weight of the water-activated catalyst based on the total weight of the silicone composition. In some embodiments, the silicone composition comprises 9% to 20% by weight of the water-activated catalyst based on the total weight of the silicone composition. In some embodiments, the silicone composition comprises 10% to 20% by weight of the water-activated catalyst based on the total weight of the silicone composition. In some embodiments, the silicone composition comprises 11% to 20% by weight of the water-activated catalyst based on the total weight of the silicone composition. In some embodiments, the silicone composition comprises 12% to 20% by weight of the water-activated catalyst based on the total weight of the silicone composition. In some embodiments, the silicone composition comprises 13% to 20% by weight of the water-activated catalyst based on the total weight of the silicone composition. In some embodiments, the silicone composition comprises 14% to 20% by weight of the water-activated catalyst based on the total weight of the silicone composition. In some embodiments, the silicone composition comprises 15% to 20% by weight of the water-activated catalyst based on the total weight of the silicone composition. In some embodiments, the silicone composition comprises 16% to 20% by weight of the water-activated catalyst based on the total weight of the silicone composition. In some embodiments, the silicone composition comprises 17% to 20% by weight of the water-activated catalyst based on the total weight of the silicone composition. In some embodiments, the silicone composition comprises 18% to 20% by weight of the water-activated catalyst based on the total weight of the silicone composition. In some embodiments, the silicone composition comprises 19% to 20% by weight of the water-activated catalyst based on the total weight of the silicone composition.

In some embodiments, the silicone composition comprises 0.1% to 19% by weight of the water-activated catalyst based on the total weight of the silicone composition. In some embodiments, the silicone composition comprises 0.1% to 18% by weight of the water-activated catalyst based on the total weight of the silicone composition. In some embodiments, the silicone composition comprises 0.1% to 17% by weight of the water-activated catalyst based on the total weight of the silicone composition. In some embodiments, the silicone composition comprises 0.1% to 16% by weight of the water-activated catalyst based on the total weight of the silicone composition. In some embodiments, the silicone composition comprises 0.1% to 15% by weight of the water-activated catalyst based on the total weight of the silicone composition. In some embodiments, the silicone composition comprises 0.1% to 14% by weight of the water-activated catalyst based on the total weight of the silicone composition. In some embodiments, the silicone composition comprises 0.1% to 13% by weight of the water-activated catalyst based on the total weight of the silicone composition. In some embodiments, the silicone composition comprises 0.1% to 12% by weight of the water-activated catalyst based on the total weight of the silicone composition. In some embodiments, the silicone composition comprises 0.1% to 11% by weight of the water-activated catalyst based on the total weight of the silicone composition. In some embodiments, the silicone composition comprises 0.1% to 10% by weight of the water-activated catalyst based on the total weight of the silicone composition. In some embodiments, the silicone composition comprises 0.1% to 9% by weight of the water-activated catalyst based on the total weight of the silicone composition. In some embodiments, the silicone composition comprises 0.1% to 8% by weight of the water-activated catalyst based on the total weight of the silicone composition. In some embodiments, the silicone composition comprises 0.1% to 7% by weight of the water-activated catalyst based on the total weight of the silicone composition. In some embodiments, the silicone composition comprises 0.1% to 6% by weight of the water-activated catalyst based on the total weight of the silicone composition.

In some embodiments, the silicone composition comprises 0.1% to 5% by weight of the water-activated catalyst based on the total weight of the silicone composition. In some embodiments, the silicone composition comprises 0.1% to 4.5% by weight of the water-activated catalyst based on the total weight of the silicone composition. In some embodiments, the silicone composition comprises 0.1% to 4% by weight of the water-activated catalyst based on the total weight of the silicone composition. In some embodiments, the silicone composition comprises 0.1% to 3.5% by weight of the water-activated catalyst based on the total weight of the silicone composition. In some embodiments, the silicone composition comprises 0.1% to 3% by weight of the water-activated catalyst based on the total weight of the silicone composition. In some embodiments, the silicone composition comprises 0.1% to 2.5% by weight of the water-activated catalyst based on the total weight of the silicone composition. In some embodiments, the silicone composition comprises 0.1% to 2% by weight of the water-activated catalyst based on the total weight of the silicone composition. In some embodiments, the silicone composition comprises 0.1% to 1.5% by weight of the water-activated catalyst based on the total weight of the silicone composition. In some embodiments, the silicone composition comprises 0.1% to 1% by weight of the water-activated catalyst based on the total weight of the silicone composition. In some embodiments, the silicone composition comprises 0.1% to 0.5% by weight of the water-activated catalyst based on the total weight of the silicone composition. In some embodiments, the silicone composition comprises 1% to 5% by weight of the water-activated catalyst based on the total weight of the silicone composition. In some embodiments, the silicone composition comprises 1% to 10% by weight of the water-activated catalyst based on the total weight of the silicone composition. In some embodiments, the silicone composition comprises 0.5% to 5% by weight of the water-activated catalyst based on the total weight of the silicone composition. In some embodiments, the silicone composition comprises 0.5% to 3% by weight of the water-activated catalyst based on the total weight of the silicone composition.

In some embodiments, the silicone composition comprises a water-release agent that is capable of supplying water when subjected to at least one external stimulus. In some embodiments, the water-release agent comprises water associated with a molecule via physical adsorption or physical absorption. In some embodiments, the water-release agent comprises structural water in a crystalline lattice. In some embodiments, the water-release agent produces water via a chemical reaction, such as, for example and without limitation, at least one of decomposition, substitution, elimination, or any combination thereof, and the like. In some embodiments, the water-release agent is configured to supply or release water in response to heat. In some embodiments, the water-release agent is configured to supply or release water in response to an external stimulus other than heat. Examples of external stimuli include, without limitation, at least one of electromagnetic radiation, UV radiation, visible light radiation, shockwave, electromagnetic field, electrolysis, or any combination thereof. In some embodiments, the external stimulus (or stimuli) is sufficient to supply, produce, generate, or release water for activating the water-activated catalyst.

In some embodiments, the water-release agent is a heat-activated water-release agent. In some embodiments, the heat-activated water-release agent is different from the filler. As used herein, the term “heat-activated water-release agent” refers to an agent capable of supplying water in response to being heated. In some embodiments, the heat-activated water-release agent comprises a hydrate compound. In some embodiments, the heat-activated water-release agent comprises at least one of an inorganic hydrate compound, an organic hydrate compound, or any combination thereof. In some embodiments, the heat-activated water-release agent comprises a compound that decomposes to produce the water in response to the heating. Examples of heat-activated water-release agent include, without limitation, at least one of sodium sulfate heptahydrate, a sodium bicarbonate, an aluminum trihydrate, a sodium dihydrogen phosphate, a hydrated bentonite, a hydrated silica, a hydrated silica gel, a fumed silica, a dimethyl dichloro silane-treated fumed silica, a hydrated zeolite particle, or any combination thereof. In some embodiments, the heat-activated water-release agent comprises a sodium sulfate heptahydrate. In some embodiments, the heat-activated water-release agent comprises at least one of a sodium bicarbonate, an aluminum trihydrate, a sodium dihydrogen phosphate, or any combination thereof. In some embodiments, the heat-activated water-release agent comprises at least one of a hydrated bentonite, a hydrated silica, a hydrated silica gel, a hydrated zeolite particle, or any combination thereof. In some embodiments, the heat-activated water-release agent comprises at least one of a sodium bicarbonate, a hydrated zeolite particle, a sodium dihydrogen phosphate, or any combination thereof. In some embodiments, the heat-activated water-release agent comprises at least one of a sodium bicarbonate, an aluminum trihydrate, a hydrated bentonite, a hydrated silica, a hydrated silica gel, a hydrated zeolite particle, a sodium dihydrogen phosphate, or any combination thereof. In some embodiments, the heat-activated water-release agent comprises at least one of a sodium bicarbonate, a sodium sulfate heptahydrate, a hydrated bentonite, a hydrated silica, a hydrated silica gel, a hydrated zeolite particle, a sodium dihydrogen phosphate, or any combination thereof. In some embodiments, the heat-activated water-release agent comprises at least one of a sodium bicarbonate, a sodium sulfate heptahydrate, an aluminum trihydrate, a hydrated silica, a hydrated zeolite particle, a sodium dihydrogen phosphate, or any combination thereof. In some embodiments, the heat-activated water-release agent comprises at least one of a sodium bicarbonate, a sodium sulfate heptahydrate, an aluminum trihydrate, a hydrated bentonite, a hydrated zeolite particle, a sodium dihydrogen phosphate, or any combination thereof. In some embodiments, the hydrated silica comprises at least one of SiO₂·nH₂O, where n is 1, 2, 3, or 4. In some embodiments, the heat-activated water-release agent is selected from the group consisting of any combination of the foregoing and/or the following: a sodium bicarbonate, a sodium sulfate heptahydrate, an aluminum trihydrate, a hydrated bentonite, a hydrated silica, a hydrated zeolite particle, a sodium dihydrogen phosphate. In some embodiments, the water-curable silicone composition does not comprise the compound that decomposes to produce the water in response to heating. In some embodiments, the water-curable silicone composition does not comprise the inorganic hydrate compound. In some embodiments, the water-curable silicone composition does not comprise the organic hydrate compound. In some embodiments, the water-curable silicone composition does not comprise at least one of at least one of sodium sulfate heptahydrate, a sodium bicarbonate, an aluminum trihydrate, a sodium dihydrogen phosphate, a hydrated bentonite, a hydrated silica, a hydrated silica gel, a fumed silica, a dimethyl dichloro silane-treated fumed silica, a hydrated zeolite particle, or any combination thereof.

In some embodiments, the heat-activated water-release agent is present in the water-curable silicone composition in an amount sufficient to obtain, in response to heating, a water for activating the water-activated catalyst. In some embodiments, the silicone composition comprises 1% to 40% by weight of the heat-activated water-release agent based on the total weight of the silicone composition. In some embodiments, the silicone composition comprises 2% to 40% by weight of the heat-activated water-release agent based on the total weight of the silicone composition. In some embodiments, the silicone composition comprises 4% to 40% by weight of the heat-activated water-release agent based on the total weight of the silicone composition. In some embodiments, the silicone composition comprises 6% to 40% by weight of the heat-activated water-release agent based on the total weight of the silicone composition. In some embodiments, the silicone composition comprises 8% to 40% by weight of the heat-activated water-release agent based on the total weight of the silicone composition. In some embodiments, the silicone composition comprises 10% to 40% by weight of the heat-activated water-release agent based on the total weight of the silicone composition.

In some embodiments, the silicone composition comprises 12% to 40% by weight of the heat-activated water-release agent based on the total weight of the silicone composition. In some embodiments, the silicone composition comprises 14% to 40% by weight of the heat-activated water-release agent based on the total weight of the silicone composition. In some embodiments, the silicone composition comprises 16% to 40% by weight of the heat-activated water-release agent based on the total weight of the silicone composition. In some embodiments, the silicone composition comprises 18% to 40% by weight of the heat-activated water-release agent based on the total weight of the silicone composition. In some embodiments, the silicone composition comprises 20% to 40% by weight of the heat-activated water-release agent based on the total weight of the silicone composition.

In some embodiments, the silicone composition comprises 22% to 40% by weight of the heat-activated water-release agent based on the total weight of the silicone composition. In some embodiments, the silicone composition comprises 24% to 40% by weight of the heat-activated water-release agent based on the total weight of the silicone composition. In some embodiments, the silicone composition comprises 26% to 40% by weight of the heat-activated water-release agent based on the total weight of the silicone composition. In some embodiments, the silicone composition comprises 28% to 40% by weight of the heat-activated water-release agent based on the total weight of the silicone composition. In some embodiments, the silicone composition comprises 30% to 40% by weight of the heat-activated water-release agent based on the total weight of the silicone composition.

In some embodiments, the silicone composition comprises 32% to 40% by weight of the heat-activated water-release agent based on the total weight of the silicone composition. In some embodiments, the silicone composition comprises 34% to 40% by weight of the heat-activated water-release agent based on the total weight of the silicone composition. In some embodiments, the silicone composition comprises 36% to 40% by weight of the heat-activated water-release agent based on the total weight of the silicone composition. In some embodiments, the silicone composition comprises 38% to 40% by weight of the heat-activated water-release agent based on the total weight of the silicone composition.

In some embodiments, the silicone composition comprises 1% to 38% by weight of the heat-activated water-release agent based on the total weight of the silicone composition. In some embodiments, the silicone composition comprises 1% to 36% by weight of the heat-activated water-release agent based on the total weight of the silicone composition. In some embodiments, the silicone composition comprises 1% to 34% by weight of the heat-activated water-release agent based on the total weight of the silicone composition. In some embodiments, the silicone composition comprises 1% to 32% by weight of the heat-activated water-release agent based on the total weight of the silicone composition.

In some embodiments, the silicone composition comprises 1% to 30% by weight of the heat-activated water-release agent based on the total weight of the silicone composition. In some embodiments, the silicone composition comprises 1% to 28% by weight of the heat-activated water-release agent based on the total weight of the silicone composition. In some embodiments, the silicone composition comprises 1% to 26% by weight of the heat-activated water-release agent based on the total weight of the silicone composition. In some embodiments, the silicone composition comprises 1% to 24% by weight of the heat-activated water-release agent based on the total weight of the silicone composition. In some embodiments, the silicone composition comprises 1% to 22% by weight of the heat-activated water-release agent based on the total weight of the silicone composition.

In some embodiments, the silicone composition comprises 1% to 20% by weight of the heat-activated water-release agent based on the total weight of the silicone composition. In some embodiments, the silicone composition comprises 1% to 18% by weight of the heat-activated water-release agent based on the total weight of the silicone composition. In some embodiments, the silicone composition comprises 1% to 16% by weight of the heat-activated water-release agent based on the total weight of the silicone composition. In some embodiments, the silicone composition comprises 1% to 14% by weight of the heat-activated water-release agent based on the total weight of the silicone composition. In some embodiments, the silicone composition comprises 1% to 12% by weight of the heat-activated water-release agent based on the total weight of the silicone composition.

In some embodiments, the silicone composition comprises 1% to 10% by weight of the heat-activated water-release agent based on the total weight of the silicone composition. In some embodiments, the silicone composition comprises 1% to 8% by weight of the heat-activated water-release agent based on the total weight of the silicone composition. In some embodiments, the silicone composition comprises 1% to 6% by weight of the heat-activated water-release agent based on the total weight of the silicone composition. In some embodiments, the silicone composition comprises 1% to 4% by weight of the heat-activated water-release agent based on the total weight of the silicone composition. In some embodiments, the silicone composition comprises 1% to 2% by weight of the heat-activated water-release agent based on the total weight of the silicone composition. In some embodiments, the silicone composition comprises 5% to 15% by weight of the heat-activated water-release agent based on the total weight of the silicone composition. In some embodiments, the silicone composition comprises 5% to 20% by weight of the heat-activated water-release agent based on the total weight of the silicone composition.

In some embodiments, the silicone composition comprises a filler. In some embodiments, the filler is different from the heat-activated water-release agent. In some embodiments, the filler comprises at least one of nepheline syenite, calcium carbonate, barium sulfate, iron oxide, diatomaceous earth, melamine, quartz, colloidal silica, crystalline silica, precipitated silica, amorphous silica, fumed silica, titanium dioxide, alumina trihydrate, zinc oxide, zirconium oxide, zirconium silicate, zinc borate, chromic oxide, crystalline silica fine powder, amorphous silica fine powder, fumed silica powder, silicone rubber powder, glass powder, silica hydrogen, silica aero gel, calcium silicate, aluminum silicate, aluminum oxide, ferrite, carbon black, graphite, mica, clay, bentonite, ground quartz, kaolin, calcined kaolin, wollastonite, hydroxyapatite, hydrated alumina, magnesium hydroxide, vermiculite, talcum, slaked lime, or any combination thereof.

In some embodiments, the silicone composition comprises 0.1% to 50% by weight of the filler based on the total weight of the silicone composition. In some embodiments, the silicone composition comprises 1% to 50% by weight of the filler based on the total weight of the silicone composition. In some embodiments, the silicone composition comprises 2% to 50% by weight of the filler based on the total weight of the silicone composition. In some embodiments, the silicone composition comprises 4% to 50% by weight of the filler based on the total weight of the silicone composition. In some embodiments, the silicone composition comprises 6% to 50% by weight of the filler based on the total weight of the silicone composition. In some embodiments, the silicone composition comprises 8% to 50% by weight of the filler based on the total weight of the silicone composition. In some embodiments, the silicone composition comprises 10% to 50% by weight of the filler based on the total weight of the silicone composition.

In some embodiments, the silicone composition comprises 12% to 50% by weight of the filler based on the total weight of the silicone composition. In some embodiments, the silicone composition comprises 14% to 50% by weight of the filler based on the total weight of the silicone composition. In some embodiments, the silicone composition comprises 16% to 50% by weight of the filler based on the total weight of the silicone composition. In some embodiments, the silicone composition comprises 18% to 50% by weight of the filler based on the total weight of the silicone composition. In some embodiments, the silicone composition comprises 20% to 50% by weight of the filler based on the total weight of the silicone composition.

In some embodiments, the silicone composition comprises 22% to 50% by weight of the filler based on the total weight of the silicone composition. In some embodiments, the silicone composition comprises 24% to 50% by weight of the filler based on the total weight of the silicone composition. In some embodiments, the silicone composition comprises 26% to 50% by weight of the filler based on the total weight of the silicone composition. In some embodiments, the silicone composition comprises 28% to 50% by weight of the filler based on the total weight of the silicone composition. In some embodiments, the silicone composition comprises 30% to 50% by weight of the filler based on the total weight of the silicone composition.

In some embodiments, the silicone composition comprises 32% to 50% by weight of the filler based on the total weight of the silicone composition. In some embodiments, the silicone composition comprises 34% to 50% by weight of the filler based on the total weight of the silicone composition. In some embodiments, the silicone composition comprises 36% to 50% by weight of the filler based on the total weight of the silicone composition. In some embodiments, the silicone composition comprises 38% to 50% by weight of the filler based on the total weight of the silicone composition. In some embodiments, the silicone composition comprises 40% to 50% by weight of the filler based on the total weight of the silicone composition.

In some embodiments, the silicone composition comprises 42% to 50% by weight of the filler based on the total weight of the silicone composition. In some embodiments, the silicone composition comprises 44% to 50% by weight of the filler based on the total weight of the silicone composition. In some embodiments, the silicone composition comprises 46% to 50% by weight of the filler based on the total weight of the silicone composition. In some embodiments, the silicone composition comprises 48% to 50% by weight of the filler based on the total weight of the silicone composition.

In some embodiments, the silicone composition comprises 1% to 48% by weight of the filler based on the total weight of the silicone composition. In some embodiments, the silicone composition comprises 1% to 46% by weight of the filler based on the total weight of the silicone composition. In some embodiments, the silicone composition comprises 1% to 44% by weight of the filler based on the total weight of the silicone composition. In some embodiments, the silicone composition comprises 1% to 42% by weight of the filler based on the total weight of the silicone composition.

In some embodiments, the silicone composition comprises 1% to 40% by weight of the filler based on the total weight of the silicone composition. In some embodiments, the silicone composition comprises 1% to 38% by weight of the filler based on the total weight of the silicone composition. In some embodiments, the silicone composition comprises 1% to 36% by weight of the filler based on the total weight of the silicone composition. In some embodiments, the silicone composition comprises 1% to 34% by weight of the filler based on the total weight of the silicone composition. In some embodiments, the silicone composition comprises 1% to 32% by weight of the filler based on the total weight of the silicone composition.

In some embodiments, the silicone composition comprises 1% to 30% by weight of the filler based on the total weight of the silicone composition. In some embodiments, the silicone composition comprises 1% to 28% by weight of the filler based on the total weight of the silicone composition. In some embodiments, the silicone composition comprises 1% to 26% by weight of the filler based on the total weight of the silicone composition. In some embodiments, the silicone composition comprises 1% to 24% by weight of the filler based on the total weight of the silicone composition. In some embodiments, the silicone composition comprises 1% to 22% by weight of the filler based on the total weight of the silicone composition.

In some embodiments, the silicone composition comprises 1% to 20% by weight of the filler based on the total weight of the silicone composition. In some embodiments, the silicone composition comprises 1% to 18% by weight of the filler based on the total weight of the silicone composition. In some embodiments, the silicone composition comprises 1% to 16% by weight of the filler based on the total weight of the silicone composition. In some embodiments, the silicone composition comprises 1% to 14% by weight of the filler based on the total weight of the silicone composition. In some embodiments, the silicone composition comprises 1% to 12% by weight of the filler based on the total weight of the silicone composition.

In some embodiments, the silicone composition comprises 1% to 10% by weight of the filler based on the total weight of the silicone composition. In some embodiments, the silicone composition comprises 1% to 8% by weight of the filler based on the total weight of the silicone composition. In some embodiments, the silicone composition comprises 1% to 6% by weight of the filler based on the total weight of the silicone composition. In some embodiments, the silicone composition comprises 1% to 4% by weight of the filler based on the total weight of the silicone composition. In some embodiments, the silicone composition comprises 1% to 2% by weight of the filler based on the total weight of the silicone composition.

In some embodiments, the silicone composition comprises an adhesion promoter. In some embodiments, the adhesion promoter comprises at least one of dichlorodimethyl silane, a silica, a fumed silica, N-(2-aminoethyl)-3-aminopropyltrimethoxysilane, vinyl tris(2-methoxyethoxy) silane, 3-methacryloxypropyltrimethoxysilane, 2-(3,4-epoxycyclohexyl)ethyl trimethoxysilane, 3-glycidoxypropyltrimethoxysilane, 3-glycidoxypropylmethyldiethoxysilane, N-(2-aminoethyl) 3-aminopropyltrimethoxysilane, 3-aminopropyltriethoxysilane, 3-(N-aminomethylbenzylamino)propyltrimethoxysilane, 3-mercaptopropyltrimethoxysilane, 3-aminopropyltris(methylethylketoxime) silane, 3-glycidoxy propyltriisopropenoxysilane, 3-glycidoxypropylmethyldiisopropenoxysilane, any reaction product thereof, or any combination thereof. In some embodiments, the adhesion promoter is a reaction product of dichlorodimethylsilane and a silica agent. In some embodiments, the silica agent comprises a fumed silica.

In some embodiments, the silicone composition comprises 0.1% to 10% by weight of the adhesion promoter based on the total weight of the silicone composition. In some embodiments, the silicone composition comprises 0.1% to 9% by weight of the adhesion promoter based on the total weight of the silicone composition. In some embodiments, the silicone composition comprises 0.1% to 8% by weight of the adhesion promoter based on the total weight of the silicone composition. In some embodiments, the silicone composition comprises 0.1% to 7% by weight of the adhesion promoter based on the total weight of the silicone composition. In some embodiments, the silicone composition comprises 0.1% to 6% by weight of the adhesion promoter based on the total weight of the silicone composition. In some embodiments, the silicone composition comprises 0.5% to 5% by weight of the adhesion promoter based on the total weight of the silicone composition. In some embodiments, the silicone composition comprises 0.1% to 5% by weight of the adhesion promoter based on the total weight of the silicone composition. In some embodiments, the silicone composition comprises 0.1% to 4% by weight of the adhesion promoter based on the total weight of the silicone composition. In some embodiments, the silicone composition comprises 0.1% to 3% by weight of the adhesion promoter based on the total weight of the silicone composition. In some embodiments, the silicone composition comprises 0.1% to 2% by weight of the adhesion promoter based on the total weight of the silicone composition. In some embodiments, the silicone composition comprises 0.1% to 1% by weight of the adhesion promoter based on the total weight of the silicone composition.

In some embodiments, the silicone composition comprises 0.5% to 10% by weight of the adhesion promoter based on the total weight of the silicone composition. In some embodiments, the silicone composition comprises 1% to 10% by weight of the adhesion promoter based on the total weight of the silicone composition. In some embodiments, the silicone composition comprises 2% to 10% by weight of the adhesion promoter based on the total weight of the silicone composition. In some embodiments, the silicone composition comprises 3% to 10% by weight of the adhesion promoter based on the total weight of the silicone composition. In some embodiments, the silicone composition comprises 4% to 10% by weight of the adhesion promoter based on the total weight of the silicone composition. In some embodiments, the silicone composition comprises 5% to 10% by weight of the adhesion promoter based on the total weight of the silicone composition. In some embodiments, the silicone composition comprises 6% to 10% by weight of the adhesion promoter based on the total weight of the silicone composition. In some embodiments, the silicone composition comprises 7% to 10% by weight of the adhesion promoter based on the total weight of the silicone composition. In some embodiments, the silicone composition comprises 8% to 10% by weight of the adhesion promoter based on the total weight of the silicone composition. In some embodiments, the silicone composition comprises 9% to 10% by weight of the adhesion promoter based on the total weight of the silicone composition. In some embodiments, the silicone composition comprises 1% to 15% by weight of the adhesion promoter based on the total weight of the silicone composition. In some embodiments, the silicone composition comprises 1% to 5% by weight of the adhesion promoter based on the total weight of the silicone composition. In some embodiments, the silicone composition comprises 1% to 3% by weight of the adhesion promoter based on the total weight of the silicone composition.

In some embodiments, the silicone composition comprises a pigment. In some embodiments, the pigment comprises at least one of zinc oxide, antimony oxide, zirconium oxide, chromium oxide, iron oxide, lead oxide, zinc sulfide, titanium dioxide (anatase, rutile, or brookite), lithopone, and carbon black, or any combination thereof.

In some embodiments, the silicone composition comprises 0.1% to 20% by weight of the pigment based on the total weight of the silicone composition. In some embodiments, the silicone composition comprises 0.1% to 19% by weight of the pigment based on the total weight of the silicone composition. In some embodiments, the silicone composition comprises 0.1% to 18% by weight of the pigment based on the total weight of the silicone composition. In some embodiments, the silicone composition comprises 0.1% to 17% by weight of the pigment based on the total weight of the silicone composition. In some embodiments, the silicone composition comprises 0.1% to 16% by weight of the pigment based on the total weight of the silicone composition. In some embodiments, the silicone composition comprises 0.1% to 15% by weight of the pigment based on the total weight of the silicone composition. In some embodiments, the silicone composition comprises 0.1% to 14% by weight of the pigment based on the total weight of the silicone composition. In some embodiments, the silicone composition comprises 0.1% to 13% by weight of the pigment based on the total weight of the silicone composition. In some embodiments, the silicone composition comprises 0.1% to 12% by weight of the pigment based on the total weight of the silicone composition. In some embodiments, the silicone composition comprises 0.1% to 11% by weight of the pigment based on the total weight of the silicone composition. In some embodiments, the silicone composition comprises 0.1% to 10% by weight of the pigment based on the total weight of the silicone composition. In some embodiments, the silicone composition comprises 0.1% to 9% by weight of the pigment based on the total weight of the silicone composition. In some embodiments, the silicone composition comprises 0.1% to 8% by weight of the pigment based on the total weight of the silicone composition. In some embodiments, the silicone composition comprises 0.1% to 7% by weight of the pigment based on the total weight of the silicone composition. In some embodiments, the silicone composition comprises 0.1% to 6% by weight of the pigment based on the total weight of the silicone composition. In some embodiments, the silicone composition comprises 0.1% to 5% by weight of the pigment based on the total weight of the silicone composition. In some embodiments, the silicone composition comprises 0.1% to 4% by weight of the pigment based on the total weight of the silicone composition. In some embodiments, the silicone composition comprises 0.1% to 3% by weight of the pigment based on the total weight of the silicone composition. In some embodiments, the silicone composition comprises 0.1% to 2% by weight of the pigment based on the total weight of the silicone composition. In some embodiments, the silicone composition comprises 0.1% to 1% by weight of the pigment based on the total weight of the silicone composition. In some embodiments, the silicone composition comprises 0.1% to 0.5% by weight of the pigment based on the total weight of the silicone composition.

In some embodiments, the silicone composition comprises 0.5% to 15% by weight of the pigment based on the total weight of the silicone composition. In some embodiments, the silicone composition comprises 1% to 15% by weight of the pigment based on the total weight of the silicone composition. In some embodiments, the silicone composition comprises 2% to 15% by weight of the pigment based on the total weight of the silicone composition. In some embodiments, the silicone composition comprises 3% to 15% by weight of the pigment based on the total weight of the silicone composition. In some embodiments, the silicone composition comprises 4% to 15% by weight of the pigment based on the total weight of the silicone composition. In some embodiments, the silicone composition comprises 5% to 15% by weight of the pigment based on the total weight of the silicone composition. In some embodiments, the silicone composition comprises 6% to 15% by weight of the pigment based on the total weight of the silicone composition. In some embodiments, the silicone composition comprises 7% to 15% by weight of the pigment based on the total weight of the silicone composition. In some embodiments, the silicone composition comprises 8% to 15% by weight of the pigment based on the total weight of the silicone composition. In some embodiments, the silicone composition comprises 9% to 15% by weight of the pigment based on the total weight of the silicone composition. In some embodiments, the silicone composition comprises 10% to 15% by weight of the pigment based on the total weight of the silicone composition. In some embodiments, the silicone composition comprises 11% to 15% by weight of the pigment based on the total weight of the silicone composition. In some embodiments, the silicone composition comprises 12% to 15% by weight of the pigment based on the total weight of the silicone composition. In some embodiments, the silicone composition comprises 13% to 15% by weight of the pigment based on the total weight of the silicone composition. In some embodiments, the silicone composition comprises 14% to 15% by weight of the pigment based on the total weight of the silicone composition. In some embodiments, the silicone composition comprises 1% to 20% by weight of the pigment based on the total weight of the silicone composition. In some embodiments, the silicone composition comprises 1% to 10% by weight of the pigment based on the total weight of the silicone composition.

In some embodiments, the silicone composition comprises a plasticizer. In some embodiments, the plasticizer comprises at least one of polyethylene glycol, polypropylene glycol, polyether diol, iso-decyl benzoate, triethylene glycol bis(2-ethylhexanoate), ethoxylated castor oil, oleic acid ethoxylate, alkylphenol ethoxylates, copolymers of ethylene oxide (EO) and propylene oxide (PO), silicone polyether copolymers, or any combination thereof.

In some embodiments, the silicone composition comprises 0.1% to 15% by weight of the plasticizer based on the total weight of the silicone composition. In some embodiments, the silicone composition comprises 0.1% to 14% by weight of the plasticizer based on the total weight of the silicone composition. In some embodiments, the silicone composition comprises 0.1% to 13% by weight of the plasticizer based on the total weight of the silicone composition. In some embodiments, the silicone composition comprises 0.1% to 12% by weight of the plasticizer based on the total weight of the silicone composition. In some embodiments, the silicone composition comprises 0.1% to 11% by weight of the plasticizer based on the total weight of the silicone composition. In some embodiments, the silicone composition comprises 0.1% to 10% by weight of the plasticizer based on the total weight of the silicone composition. In some embodiments, the silicone composition comprises 0.1% to 9% by weight of the plasticizer based on the total weight of the silicone composition. In some embodiments, the silicone composition comprises 0.1% to 8% by weight of the plasticizer based on the total weight of the silicone composition. In some embodiments, the silicone composition comprises 0.1% to 7% by weight of the plasticizer based on the total weight of the silicone composition. In some embodiments, the silicone composition comprises 0.1% to 6% by weight of the plasticizer based on the total weight of the silicone composition. In some embodiments, the silicone composition comprises 0.1% to 5% by weight of the plasticizer based on the total weight of the silicone composition. In some embodiments, the silicone composition comprises 0.1% to 4% by weight of the plasticizer based on the total weight of the silicone composition. In some embodiments, the silicone composition comprises 0.1% to 3% by weight of the plasticizer based on the total weight of the silicone composition. In some embodiments, the silicone composition comprises 0.1% to 2% by weight of the plasticizer based on the total weight of the silicone composition. In some embodiments, the silicone composition comprises 0.1% to 1% by weight of the plasticizer based on the total weight of the silicone composition. In some embodiments, the silicone composition comprises 0.1% to 0.5% by weight of the plasticizer based on the total weight of the silicone composition. In some embodiments, the silicone composition comprises 1% to 10% by weight of the plasticizer based on the total weight of the silicone composition. In some embodiments, the silicone composition comprises 1% to 15% by weight of the plasticizer based on the total weight of the silicone composition.

In some embodiments, the silicone composition comprises 0.5% to 15% by weight of the plasticizer based on the total weight of the silicone composition. In some embodiments, the silicone composition comprises 1% to 15% by weight of the plasticizer based on the total weight of the silicone composition. In some embodiments, the silicone composition comprises 2% to 15% by weight of the plasticizer based on the total weight of the silicone composition. In some embodiments, the silicone composition comprises 3% to 15% by weight of the plasticizer based on the total weight of the silicone composition. In some embodiments, the silicone composition comprises 4% to 15% by weight of the plasticizer based on the total weight of the silicone composition. In some embodiments, the silicone composition comprises 5% to 15% by weight of the plasticizer based on the total weight of the silicone composition. In some embodiments, the silicone composition comprises 6% to 15% by weight of the plasticizer based on the total weight of the silicone composition. In some embodiments, the silicone composition comprises 7% to 15% by weight of the plasticizer based on the total weight of the silicone composition. In some embodiments, the silicone composition comprises 8% to 15% by weight of the plasticizer based on the total weight of the silicone composition. In some embodiments, the silicone composition comprises 9% to 15% by weight of the plasticizer based on the total weight of the silicone composition. In some embodiments, the silicone composition comprises 10% to 15% by weight of the plasticizer based on the total weight of the silicone composition. In some embodiments, the silicone composition comprises 11% to 15% by weight of the plasticizer based on the total weight of the silicone composition. In some embodiments, the silicone composition comprises 12% to 15% by weight of the plasticizer based on the total weight of the silicone composition. In some embodiments, the silicone composition comprises 13% to 15% by weight of the plasticizer based on the total weight of the silicone composition. In some embodiments, the silicone composition comprises 14% to 15% by weight of the plasticizer based on the total weight of the silicone composition.

In some embodiments, the silicone composition comprises one or more additives. In some embodiments, the one or more additives comprise at least one of a reinforcing fiber, a wetting agent, a dispersant, a thickener (or a rheology modifier), a plasticizer, a surfactant, a compatibilizer, a dehydrating agent, a pH adjuster (e.g., basic compounds such as, for example and without limitation sodium hydroxide, 2-amino-2-methyl-1-propanol, ammonia, etc.; and/or acidic compounds, such as, for example and without limitation, hydrochloric acid, acetic acid, phosphoric acid, citric acid, etc.), a biocide, a processing aid, an antioxidant, an ageing inhibitor, a buffer, an antimicrobial agent, or any combination thereof. In some embodiments, the silicone composition does not comprise any of the one or more additives.

In some embodiments, the silicone composition comprises 0.01% to 50% by weight of at least one additive based on the total weight of the silicone composition. In some embodiments, the silicone composition comprises 0.01% to 45% by weight of at least one additive based on the total weight of the silicone composition. In some embodiments, the silicone composition comprises 0.01% to 40% by weight of at least one additive based on the total weight of the silicone composition. In some embodiments, the silicone composition comprises 0.01% to 35% by weight of at least one additive based on the total weight of the silicone composition. In some embodiments, the silicone composition comprises 0.01% to 30% by weight of at least one additive based on the total weight of the silicone composition. In some embodiments, the silicone composition comprises 0.01% to 25% by weight of at least one additive based on the total weight of the silicone composition. In some embodiments, the silicone composition comprises 0.01% to 20% by weight of at least one additive based on the total weight of the silicone composition. In some embodiments, the silicone composition comprises 0.01% to 15% by weight of at least one additive based on the total weight of the silicone composition. In some embodiments, the silicone composition comprises 0.01% to 10% by weight of at least one additive based on the total weight of the silicone composition. In some embodiments, the silicone composition comprises 0.01% to 5% by weight of at least one additive based on the total weight of the silicone composition. In some embodiments, the silicone composition comprises 0.01% to 1% by weight of at least one additive based on the total weight of the silicone composition. In some embodiments, the silicone composition comprises 0.01% to 0.5% by weight of at least one additive based on the total weight of the silicone composition.

In some embodiments, the silicone composition comprises 1% to 50% by weight of at least one additive based on the total weight of the silicone composition. In some embodiments, the silicone composition comprises 5% to 50% by weight of at least one additive based on the total weight of the silicone composition. In some embodiments, the silicone composition comprises 10% to 50% by weight of at least one additive based on the total weight of the silicone composition. In some embodiments, the silicone composition comprises 15% to 50% by weight of at least one additive based on the total weight of the silicone composition. In some embodiments, the silicone composition comprises 20% to 50% by weight of at least one additive based on the total weight of the silicone composition. In some embodiments, the silicone composition comprises 25% to 50% by weight of at least one additive based on the total weight of the silicone composition. In some embodiments, the silicone composition comprises 30% to 50% by weight of at least one additive based on the total weight of the silicone composition. In some embodiments, the silicone composition comprises 35% to 50% by weight of at least one additive based on the total weight of the silicone composition. In some embodiments, the silicone composition comprises 40% to 50% by weight of at least one additive based on the total weight of the silicone composition. In some embodiments, the silicone composition comprises 45% to 50% by weight of at least one additive based on the total weight of the silicone composition.

In some embodiments, the silicone composition comprises a solvent. For example, in some embodiments, the silicone composition comprises water. In some embodiments, the silicone composition comprises an organic solvent. In some embodiments, the silicone composition comprises toluene. In some embodiments, the silicone composition comprises hexane. In some embodiments, the silicone composition comprises xylene. In some embodiments, the silicone composition does not comprise a solvent.

In some embodiments, the silicone composition comprises 1% to 50% by weight of the solvent based on the total weight of the silicone composition. In some embodiments, the silicone composition comprises 1% to 45% by weight of the solvent based on the total weight of the silicone composition. In some embodiments, the silicone composition comprises 1% to 40% by weight of the solvent based on the total weight of the silicone composition. In some embodiments, the silicone composition comprises 1% to 35% by weight of the solvent based on the total weight of the silicone composition. In some embodiments, the silicone composition comprises 1% to 30% by weight of the solvent based on the total weight of the silicone composition. In some embodiments, the silicone composition comprises 1% to 25% by weight of the solvent based on the total weight of the silicone composition. In some embodiments, the silicone composition comprises 1% to 20% by weight of the solvent based on the total weight of the silicone composition. In some embodiments, the silicone composition comprises 1% to 15% by weight of the solvent based on the total weight of the silicone composition. In some embodiments, the silicone composition comprises 1% to 10% by weight of the solvent based on the total weight of the silicone composition. In some embodiments, the silicone composition comprises 1% to 5% by weight of the solvent based on the total weight of the silicone composition.

In some embodiments, the silicone composition comprises 5% to 50% by weight of the solvent based on the total weight of the silicone composition. In some embodiments, the silicone composition comprises 10% to 50% by weight of the solvent based on the total weight of the silicone composition. In some embodiments, the silicone composition comprises 15% to 50% by weight of the solvent based on the total weight of the silicone composition. In some embodiments, the silicone composition comprises 20% to 50% by weight of the solvent based on the total weight of the silicone composition. In some embodiments, the silicone composition comprises 25% to 50% by weight of the solvent based on the total weight of the silicone composition. In some embodiments, the silicone composition comprises 30% to 50% by weight of the solvent based on the total weight of the silicone composition. In some embodiments, the silicone composition comprises 35% to 50% by weight of the solvent based on the total weight of the silicone composition. In some embodiments, the silicone composition comprises 40% to 50% by weight of the solvent based on the total weight of the silicone composition. In some embodiments, the silicone composition comprises 45% to 50% by weight of the solvent based on the total weight of the silicone composition.

In some embodiments, when heated to a temperature of 250° C. or less, the heat-activated water-release agent supplies sufficient water for activating the water-activated catalyst. In some embodiments, when heated to a temperature of 240° C. or less, the heat-activated water-release agent supplies sufficient water for activating the water-activated catalyst. In some embodiments, when heated to a temperature of 230° C. or less, the heat-activated water-release agent supplies sufficient water for activating the water-activated catalyst. In some embodiments, when heated to a temperature of 220° C. or less, the heat-activated water-release agent supplies sufficient water for activating the water-activated catalyst. In some embodiments, when heated to a temperature of 210° C. or less, the heat-activated water-release agent supplies sufficient water for activating the water-activated catalyst. In some embodiments, when heated to a temperature of 200° C. or less, the heat-activated water-release agent supplies sufficient water for activating the water-activated catalyst. In some embodiments, when heated to a temperature of 190° C. or less, the heat-activated water-release agent supplies sufficient water for activating the water-activated catalyst. In some embodiments, when heated to a temperature of 180° C. or less, the heat-activated water-release agent supplies sufficient water for activating the water-activated catalyst. In some embodiments, when heated to a temperature of 170° C. or less, the heat-activated water-release agent supplies sufficient water for activating the water-activated catalyst. In some embodiments, when heated to a temperature of 160° C. or less, the heat-activated water-release agent supplies sufficient water for activating the water-activated catalyst. In some embodiments, when heated to a temperature of 150° C. or less, the heat-activated water-release agent supplies sufficient water for activating the water-activated catalyst. In some embodiments, when heated to a temperature of 140° C. or less, the heat-activated water-release agent supplies sufficient water for activating the water-activated catalyst. In some embodiments, when heated to a temperature of 130° C. or less, the heat-activated water-release agent supplies sufficient water for activating the water-activated catalyst. In some embodiments, when heated to a temperature of 120° C. or less, the heat-activated water-release agent supplies sufficient water for activating the water-activated catalyst. In some embodiments, when heated to a temperature of 110° C. or less, the heat-activated water-release agent supplies sufficient water for activating the water-activated catalyst. In some embodiments, when heated to a temperature of 100° C. or less, the heat-activated water-release agent supplies sufficient water for activating the water-activated catalyst. In some embodiments, when heated to a temperature of 90° C. or less, the heat-activated water-release agent supplies sufficient water for activating the water-activated catalyst. In some embodiments, when heated to a temperature of 80° C. or less, the heat-activated water-release agent supplies sufficient water for activating the water-activated catalyst. In some embodiments, when heated to a temperature of 70° C. or less, the heat-activated water-release agent supplies sufficient water for activating the water-activated catalyst. In some embodiments, when heated to a temperature of 60° C. or less, the heat-activated water-release agent supplies sufficient water for activating the water-activated catalyst. In some embodiments, when heated to a temperature of 50° C. or less, the heat-activated water-release agent supplies sufficient water for activating the water-activated catalyst. In some embodiments, when heated to a temperature of 40° C. or less, the heat-activated water-release agent supplies sufficient water for activating the water-activated catalyst. In some embodiments, when heated to a temperature of 30° C. or less, the heat-activated water-release agent supplies sufficient water for activating the water-activated catalyst.

In some embodiments, when heated to a temperature of at least 20° C., the heat-activated water-release agent supplies sufficient water for activating the water-activated catalyst. In some embodiments, when heated to a temperature of at least 30° C., the heat-activated water-release agent supplies sufficient water for activating the water-activated catalyst. In some embodiments, when heated to a temperature of at least 40° C., the heat-activated water-release agent supplies sufficient water for activating the water-activated catalyst. In some embodiments, when heated to a temperature of at least 50° C., the heat-activated water-release agent supplies sufficient water for activating the water-activated catalyst. In some embodiments, when heated to a temperature of at least 60° C., the heat-activated water-release agent supplies sufficient water for activating the water-activated catalyst. In some embodiments, when heated to a temperature of at least 70° C., the heat-activated water-release agent supplies sufficient water for activating the water-activated catalyst. In some embodiments, when heated to a temperature of at least 80° C., the heat-activated water-release agent supplies sufficient water for activating the water-activated catalyst. In some embodiments, when heated to a temperature of at least 90° C., the heat-activated water-release agent supplies sufficient water for activating the water-activated catalyst. In some embodiments, when heated to a temperature of at least 100° C., the heat-activated water-release agent supplies sufficient water for activating the water-activated catalyst.

In some embodiments, when heated to a temperature of at least 110° C., the heat-activated water-release agent supplies sufficient water for activating the water-activated catalyst. In some embodiments, when heated to a temperature of at least 120° C., the heat-activated water-release agent supplies sufficient water for activating the water-activated catalyst. In some embodiments, when heated to a temperature of at least 130° C., the heat-activated water-release agent supplies sufficient water for activating the water-activated catalyst. In some embodiments, when heated to a temperature of at least 140° C., the heat-activated water-release agent supplies sufficient water for activating the water-activated catalyst. In some embodiments, when heated to a temperature of at least 150° C., the heat-activated water-release agent supplies sufficient water for activating the water-activated catalyst. In some embodiments, when heated to a temperature of at least 160° C., the heat-activated water-release agent supplies sufficient water for activating the water-activated catalyst. In some embodiments, when heated to a temperature of at least 170° C., the heat-activated water-release agent supplies sufficient water for activating the water-activated catalyst. In some embodiments, when heated to a temperature of at least 180° C., the heat-activated water-release agent supplies sufficient water for activating the water-activated catalyst. In some embodiments, when heated to a temperature of at least 190° C., the heat-activated water-release agent supplies sufficient water for activating the water-activated catalyst. In some embodiments, when heated to a temperature of at least 200° C., the heat-activated water-release agent supplies sufficient water for activating the water-activated catalyst. In some embodiments, when heated to a temperature of at least 210° C., the heat-activated water-release agent supplies sufficient water for activating the water-activated catalyst. In some embodiments, when heated to a temperature of at least 220° C., the heat-activated water-release agent supplies sufficient water for activating the water-activated catalyst. In some embodiments, when heated to a temperature of at least 230° C., the heat-activated water-release agent supplies sufficient water for activating the water-activated catalyst. In some embodiments, when heated to a temperature of at least 240° C., the heat-activated water-release agent supplies sufficient water for activating the water-activated catalyst.

In some embodiments, when heated to a temperature of 20° C. to 250° C., the heat-activated water-release agent supplies sufficient water for activating the water-activated catalyst. In some embodiments, when heated to a temperature of 30° C. to 250° C., the heat-activated water-release agent supplies sufficient water for activating the water-activated catalyst. In some embodiments, when heated to a temperature of 40° C. to 250° C., the heat-activated water-release agent supplies sufficient water for activating the water-activated catalyst. In some embodiments, when heated to a temperature of 50° C. to 250° C., the heat-activated water-release agent supplies sufficient water for activating the water-activated catalyst. In some embodiments, when heated to a temperature of 60° C. to 250° C., the heat-activated water-release agent supplies sufficient water for activating the water-activated catalyst. In some embodiments, when heated to a temperature of 70° C. to 250° C., the heat-activated water-release agent supplies sufficient water for activating the water-activated catalyst. In some embodiments, when heated to a temperature of 80° C. to 250° C., the heat-activated water-release agent supplies sufficient water for activating the water-activated catalyst. In some embodiments, when heated to a temperature of 90° C. to 250° C., the heat-activated water-release agent supplies sufficient water for activating the water-activated catalyst. In some embodiments, when heated to a temperature of 100° C. to 250° C., the heat-activated water-release agent supplies sufficient water for activating the water-activated catalyst.

In some embodiments, when heated to a temperature of 110° C. to 250° C., the heat-activated water-release agent supplies sufficient water for activating the water-activated catalyst. In some embodiments, when heated to a temperature of 120° C. to 250° C., the heat-activated water-release agent supplies sufficient water for activating the water-activated catalyst. In some embodiments, when heated to a temperature of 130° C. to 250° C., the heat-activated water-release agent supplies sufficient water for activating the water-activated catalyst. In some embodiments, when heated to a temperature of 140° C. to 250° C., the heat-activated water-release agent supplies sufficient water for activating the water-activated catalyst. In some embodiments, when heated to a temperature of 150° C. to 250° C., the heat-activated water-release agent supplies sufficient water for activating the water-activated catalyst. In some embodiments, when heated to a temperature of 160° C. to 250° C., the heat-activated water-release agent supplies sufficient water for activating the water-activated catalyst. In some embodiments, when heated to a temperature of 170° C. to 250° C., the heat-activated water-release agent supplies sufficient water for activating the water-activated catalyst. In some embodiments, when heated to a temperature of 180° C. to 250° C., the heat-activated water-release agent supplies sufficient water for activating the water-activated catalyst. In some embodiments, when heated to a temperature of 190° C. to 250° C., the heat-activated water-release agent supplies sufficient water for activating the water-activated catalyst. In some embodiments, when heated to a temperature of 200° C. to 250° C., the heat-activated water-release agent supplies sufficient water for activating the water-activated catalyst. In some embodiments, when heated to a temperature of 210° C. to 250° C., the heat-activated water-release agent supplies sufficient water for activating the water-activated catalyst. In some embodiments, when heated to a temperature of 220° C. to 250° C., the heat-activated water-release agent supplies sufficient water for activating the water-activated catalyst. In some embodiments, when heated to a temperature of 230° C. to 250° C., the heat-activated water-release agent supplies sufficient water for activating the water-activated catalyst. In some embodiments, when heated to a temperature of 240° C. to 250° C., the heat-activated water-release agent supplies sufficient water for activating the water-activated catalyst.

In some embodiments, when heated to a temperature of 20° C. to 240° C., the heat-activated water-release agent supplies sufficient water for activating the water-activated catalyst. In some embodiments, when heated to a temperature of 20° C. to 230° C., the heat-activated water-release agent supplies sufficient water for activating the water-activated catalyst. In some embodiments, when heated to a temperature of 20° C. to 220° C., the heat-activated water-release agent supplies sufficient water for activating the water-activated catalyst. In some embodiments, when heated to a temperature of 20° C. to 210° C., the heat-activated water-release agent supplies sufficient water for activating the water-activated catalyst. In some embodiments, when heated to a temperature of 20° C. to 200° C., the heat-activated water-release agent supplies sufficient water for activating the water-activated catalyst. In some embodiments, when heated to a temperature of 20° C. to 190° C., the heat-activated water-release agent supplies sufficient water for activating the water-activated catalyst. In some embodiments, when heated to a temperature of 20° C. to 180° C., the heat-activated water-release agent supplies sufficient water for activating the water-activated catalyst. In some embodiments, when heated to a temperature of 20° C. to 170° C., the heat-activated water-release agent supplies sufficient water for activating the water-activated catalyst. In some embodiments, when heated to a temperature of 20° C. to 160° C., the heat-activated water-release agent supplies sufficient water for activating the water-activated catalyst. In some embodiments, when heated to a temperature of 20° C. to 150° C., the heat-activated water-release agent supplies sufficient water for activating the water-activated catalyst. In some embodiments, when heated to a temperature of 20° C. to 140° C., the heat-activated water-release agent supplies sufficient water for activating the water-activated catalyst. In some embodiments, when heated to a temperature of 20° C. to 130° C., the heat-activated water-release agent supplies sufficient water for activating the water-activated catalyst. In some embodiments, when heated to a temperature of 20° C. to 120° C., the heat-activated water-release agent supplies sufficient water for activating the water-activated catalyst. In some embodiments, when heated to a temperature of 20° C. to 110° C., the heat-activated water-release agent supplies sufficient water for activating the water-activated catalyst. In some embodiments, when heated to a temperature of 20° C. to 100° C., the heat-activated water-release agent supplies sufficient water for activating the water-activated catalyst.

In some embodiments, when heated to a temperature of 20° C. to 90° C., the heat-activated water-release agent supplies sufficient water for activating the water-activated catalyst. In some embodiments, when heated to a temperature of 20° C. to 80° C., the heat-activated water-release agent supplies sufficient water for activating the water-activated catalyst. In some embodiments, when heated to a temperature of 20° C. to 70° C., the heat-activated water-release agent supplies sufficient water for activating the water-activated catalyst. In some embodiments, when heated to a temperature of 20° C. to 60° C., the heat-activated water-release agent supplies sufficient water for activating the water-activated catalyst. In some embodiments, when heated to a temperature of 20° C. to 50° C., the heat-activated water-release agent supplies sufficient water for activating the water-activated catalyst. In some embodiments, when heated to a temperature of 20° C. to 40° C., the heat-activated water-release agent supplies sufficient water for activating the water-activated catalyst. In some embodiments, when heated to a temperature of 20° C. to 30° C., the heat-activated water-release agent supplies sufficient water for activating the water-activated catalyst.

In some embodiments, the water-curable silicone composition is cured or curable without any external supply of water. In some embodiments, the water-curable silicone composition is cured or curable in the presence of an external supply of water, wherein the external supply of water is not present in an amount sufficient to activate, by itself, the water-activated catalyst. In some embodiments, the water-curable silicone composition is cured or curable without an external supply of water. In some embodiments, an external supply of water refers to water supplied from sources other than the silicone composition. In some embodiments, the external supply of water refers to moisture in ambient environment. In some embodiments, the external supply of water refers to water from any source other than the silicone composition.

In some embodiments, the silicone composition is a single-component composition. That is, for example, in some embodiments, the silicone composition is produced, packaged, and stored in a single container. In some embodiments, the silicone composition is not an adhesive. In some embodiments, the silicone composition does not comprise an epoxy resin. In some embodiments, the silicone composition does not comprise a polyether containing silane groups. In some embodiments, the silicone composition does not comprise an amine hardener. In some embodiments, the silicone composition does not comprise a rheology modifier. In some embodiments, the silicone composition does not comprise a silica gel, wherein a silica gel is a hydrated silica that has been dehydrated. In some embodiments, the silicone composition does not comprise a decahydrate compound.

Some embodiments relate to method of installation. In some embodiments, the method of installation comprises obtaining a water-curable silicone composition. In some embodiments, the water-curable silicone composition comprises 10% to 80% by weight of a silanol-terminated polysiloxane based on a total weight of the water-curable silicone composition. In some embodiments, the water-curable silicone composition comprises 1% to 30% by weight of a crosslinker based on the total weight of the water-curable silicone composition. In some embodiments, the water-curable silicone composition comprises 0.1% to 20% by weight of a water-activated catalyst based on the total weight of the water-curable silicone composition. In some embodiments, the water-curable silicone composition comprises 1% to 40% by weight of a heat-activated water-release agent based on the total weight of the water-curable silicone composition. In some embodiments, the heat-activated water-release agent comprises at least one of a sodium bicarbonate, a sodium sulfate heptahydrate, an aluminum trihydrate, a hydrated bentonite, a hydrated silica, a hydrated silica gel, a hydrated zeolite particle, a sodium dihydrogen phosphate, or any combination thereof. In some embodiments, the water-curable silicone composition comprises 1% to 50% by weight of at least one filler based on the total weight of the water-curable silicone composition. In some embodiments, the method of installation comprises applying the water-curable silicone composition to at least one surface of a building structure. In some embodiments, the method of installation comprises heating the water-curable silicone composition so as to supply water from the heat-activated water-release agent. In some embodiments, the water supplied from the heat-activated water-release agent activates the water-activated catalyst. In some embodiments, the method of installation comprises curing the water-curable silicone composition so as to obtain a water-cured silicone composition.

In some embodiments, the water-curable silicone composition comprises 20% to 70% by weight of the silanol-terminated polysiloxane based on the total weight of the water-curable silicone composition.

In some embodiments, the water-curable silicone composition comprises 1% to 20% by weight of the crosslinker based on a total weight of the water-curable silicone composition.

In some embodiments, the water-curable silicone composition comprises 0.1% to 10% by weight of the water-activated catalyst based on the total weight of the water-curable silicone composition.

In some embodiments, the water-curable silicone composition comprises 1% to 30% by weight of the heat-activated water-release agent based on the total weight of the water-curable silicone composition.

In some embodiments, the heat-activated water-release agent is different from the at least one filler.

In some embodiments, the heat-activated water-release agent comprises a sodium sulfate heptahydrate.

In some embodiments, the heat-activated water-release agent comprises at least one of a sodium bicarbonate, an aluminum trihydrate, a sodium dihydrogen phosphate, or any combination thereof.

In some embodiments, the heat-activated water-release agent comprises at least one of a hydrated bentonite, a hydrated silica, a hydrated zeolite particle, or any combination thereof.

In some embodiments, the water-curable silicone composition is heated to a temperature of 20° C. to 200° C.

Some embodiments relate to a water-curable silicone composition. In some embodiments, the water-curable silicone composition comprises 10% to 80% by weight of a silanol-terminated polysiloxane based on a total weight of the water-curable silicone composition. In some embodiments, the water-curable silicone composition comprises 1% to 30% by weight of a crosslinker based on the total weight of the water-curable silicone composition. In some embodiments, the water-curable silicone composition comprises 0.1% to 20% by weight of a water-activated catalyst based on the total weight of the water-curable silicone composition. In some embodiments, the water-curable silicone composition comprises 1% to 40% by weight of a heat-activated water-release agent based on the total weight of the water-curable silicone composition. In some embodiments, the heat-activated water-release agent comprises at least one of a sodium bicarbonate, a sodium sulfate heptahydrate, an aluminum trihydrate, a hydrated bentonite, a hydrated silica, a hydrated silica gel, a hydrated zeolite particle, a sodium dihydrogen phosphate, or any combination thereof. In some embodiments, when heated to a temperature of at least 20° C., the heat-activated water-release agent supplies water for activating the water-activated catalyst. In some embodiments, the water-curable silicone composition comprises 1% to 50% by weight of at least one filler based on the total weight of the water-curable silicone composition.

In some embodiments, the water-curable silicone composition comprises 20% to 70% by weight of the silanol-terminated polysiloxane based on the total weight of the water-curable silicone composition.

In some embodiments, the water-curable silicone composition comprises 1% to 20% by weight of the crosslinker based on the total weight of the water-curable silicone composition.

In some embodiments, the water-curable silicone composition comprises 0.1% to 10% by weight of the water-activated catalyst based on the total weight of the water-curable silicone composition.

In some embodiments, the water-curable silicone composition comprises 1% to 30% by weight of the heat-activated water-release agent based on the total weight of the water-curable silicone composition.

In some embodiments, the heat-activated water-release agent comprises a sodium sulfate heptahydrate.

In some embodiments, the heat-activated water-release agent comprises at least one of a sodium bicarbonate, an aluminum trihydrate, a sodium dihydrogen phosphate, or any combination thereof.

In some embodiments, the heat-activated water-release agent comprises at least one of a hydrated bentonite, a hydrated silica, a hydrated zeolite particle, or any combination thereof.

In some embodiments, the heat-activated water-release agent is different from the at least one filler.

In some embodiments, the heat-activated water-release agent supplies water for activating the water-activated catalyst when heated to a temperature of 20° C. to 200° C.

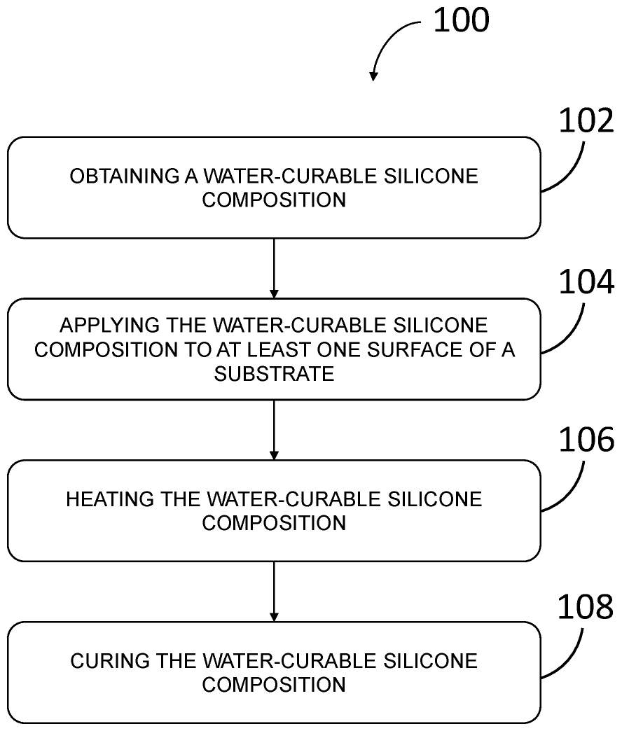

FIG. 1 is a flowchart of a method of installation 100, according to some embodiments. As shown in FIG. 1, in some embodiments, the method of installation 100 comprises obtaining 102 a water-curable silicone composition. In some embodiments, the method of installation 100 comprises applying 104 the water-curable silicone composition to at least one surface of a substrate. In some embodiments, the method of installation 100 comprises heating 106 the water-curable silicone composition so as to supply water from the heat-activated water-release agent, wherein the water supplied from the heat-activated water-release agent activates the water-activated catalyst. In some embodiments, the method of installation 100 comprises curing 108 the water-curable silicone composition so as to obtain a water-cured silicone composition.

In some embodiments, the method of installation 100 comprises obtaining 102 a water-curable silicone composition. In some embodiments, the water-curable silicone composition comprises any one of the silicone compositions disclosed herein.

In some embodiments, the method of installation 100 comprises applying 104 the water-curable silicone composition to at least one surface of a substrate. In some embodiments, the applying 104 comprises coating the water-curable silicone composition onto the at least one surface of a substrate. In some embodiments, the applying 104 comprises spraying the water-curable silicone composition onto the at least one surface of a substrate. In some embodiments, the applying 104 comprises disposing the water-curable silicone composition onto the at least one surface of a substrate. In some embodiments, the applying 104 comprises pouring the water-curable silicone composition onto the at least one surface of a substrate. In some embodiments, the applying 104 comprises rolling (e.g., using a roller) the water-curable silicone composition onto the at least one surface of a substrate. In some embodiments, the applying 104 comprises brushing (e.g., using a brush) the water-curable silicone composition onto the at least one surface of a substrate. In some embodiments, the applying 104 comprises gunning the water-curable silicone composition onto the at least one surface of a substrate. In some embodiments, the applying 104 comprises contacting the water-curable silicone composition with the at least one surface of a substrate.

In some embodiments, the substrate comprises at least one of a mesh, a fabric, or any combination thereof. In some embodiments, the substrate is woven. In some embodiments, the substrate is nonwoven. In some embodiments, the substrate comprises a polyester fabric, a polyester mat, a fiberglass mat, a knit, a scrim, a fibrous support, synthetic fibers, or any combination thereof. In some embodiments, the substrate comprises, for example, at least one of glass, silica, metals, ceramic, silicon carbide, carbon, boron, basalt. In some embodiments, the synthetic fibers comprise at leas tone of polyesters, polyamides, polyacrylics, chlorofibres, polyolefins, synthetic rubbers, polyvinyl alcohol, aramides, phenolics, or any combination thereof.

In some embodiments, the at least one surface of a substrate is at least one surface of a building structure. As used herein, the term “building structure” refers to any structural component of a building. For example, in some embodiments, a building structure comprises at least one of a parapet wall, a roof substrate, a roof deck, a skylight, a roof edge, a building wall, a roof penetration, rough openings such as a window frame and/or a door frame, a seam between walls and other structures, a pipe, a corner, an edge, an overhang, a coating, a framing, a through-hole in a wall, or any combination thereof. In some embodiments, a roof deck is a structure supporting a roof. In some embodiments, a roof substrate comprises at least one of a plywood substrate, a glass substrate, a cellulosic substrate, a roof shingle, a mat, a fabric, a glass mat, a fiberglass mat, an underlayment, a roofing membrane, a roof deck, a photovoltaic (PV) panel, a modified bitumen (MODBIT) substrate, a roll good, a board (such as but not limited to at least one of a foam board (e.g., a polyisocyanurate (ISO) foam board), a cover board, or any combination thereof), a pipe, a base sheet, a chimney, a wax paper, or any combination thereof. In some embodiments, a parapet wall is a barrier at an edge of a structure, such as, for example and without limitation, at least one of a roof, a terrace, a balcony, a walkway, or any combination thereof, and the like.

In some embodiments, the at least one surface of the building structure comprises an exterior surface of the building structure. In some embodiments, the at least one surface of a building structure comprises an interior surface of the building structure. In some embodiments, the at least one surface of a building structure comprises a sheathing. In some embodiments, the at least one surface of a building structure comprises a wall. In some embodiments, the at least one surface of a building structure comprises a board. In some embodiments, the at least one surface of a building structure comprises a structural framing. In some embodiments, the at least one surface of a building structure comprises a roof deck. In some embodiments, the at least one surface of a building structure comprises a through-hole in a wall. In some embodiments, the at least one surface of a building structure comprises a window frame. In some embodiments, the at least one surface of a building structure comprises a below-grade surface. In some embodiments, the at least one surface of a building structure comprises an above-grade surface. In some embodiments, the at least one surface of a building structure comprises a panel. In some embodiments, the at least one surface of a building structure comprises a membrane.

In some embodiments, the method of installation 100 comprises heating 106 the water-curable silicone composition. In some embodiments, the heating 106 is sufficient to supply water from the heat-activated water-release agent such that the water supplied from the heat-activated water-release agent activates the water-activated catalyst. In some embodiments, the heating is sufficient for disassociating water molecules from the heat-activated water-release agent, so as to obtain the water. In some embodiments, the heating is sufficient for decomposing the heat-activated water-release agent, so as to obtain the water. In some embodiments, the heating 106 comprises heating the water-curable silicone composition or any component thereof to a temperature. In some embodiments, the heating 106 comprises heating the water-curable silicone composition or any component thereof at a temperature.

In some embodiments, the heating 106 comprising heating at or to a temperature in a range of 20° C. to 250° C. In some embodiments, the heating 106 comprising heating at or to a temperature in a range of 30° C. to 250° C. In some embodiments, the heating 106 comprising heating at or to a temperature in a range of 40° C. to 250° C. In some embodiments, the heating 106 comprising heating at or to a temperature in a range of 50° C. to 250° C. In some embodiments, the heating 106 comprising heating at or to a temperature in a range of 60° C. to 250° C. In some embodiments, the heating 106 comprising heating at or to a temperature in a range of 70° C. to 250° C. In some embodiments, the heating 106 comprising heating at or to a temperature in a range of 80° C. to 250° C. In some embodiments, the heating 106 comprising heating at or to a temperature in a range of 90° C. to 250° C. In some embodiments, the heating 106 comprising heating at or to a temperature in a range of 100° C. to 250° C.

In some embodiments, the heating 106 comprising heating at or to a temperature in a range of 110° C. to 250° C. In some embodiments, the heating 106 comprising heating at or to a temperature in a range of 120° C. to 250° C. In some embodiments, the heating 106 comprising heating at or to a temperature in a range of 130° C. to 250° C. In some embodiments, the heating 106 comprising heating at or to a temperature in a range of 140° C. to 250° C. In some embodiments, the heating 106 comprising heating at or to a temperature in a range of 150° C. to 250° C. In some embodiments, the heating 106 comprising heating at or to a temperature in a range of 160° C. to 250° C. In some embodiments, the heating 106 comprising heating at or to a temperature in a range of 170° C. to 250° C. In some embodiments, the heating 106 comprising heating at or to a temperature in a range of 180° C. to 250° C. In some embodiments, the heating 106 comprising heating at or to a temperature in a range of 190° C. to 250° C. In some embodiments, the heating 106 comprising heating at or to a temperature in a range of 200° C. to 250° C. In some embodiments, the heating 106 comprising heating at or to a temperature in a range of 210° C. to 250° C. In some embodiments, the heating 106 comprising heating at or to a temperature in a range of 220° C. to 250° C. In some embodiments, the heating 106 comprising heating at or to a temperature in a range of 230° C. to 250° C. In some embodiments, the heating 106 comprising heating at or to a temperature in a range of 240° C. to 250° C.

In some embodiments, the heating 106 comprising heating at or to a temperature in a range of 20° C. to 240° C. In some embodiments, the heating 106 comprising heating at or to a temperature in a range of 20° C. to 230° C. In some embodiments, the heating 106 comprising heating at or to a temperature in a range of 20° C. to 220° C. In some embodiments, the heating 106 comprising heating at or to a temperature in a range of 20° C. to 210° C. In some embodiments, the heating 106 comprising heating at or to a temperature in a range of 20° C. to 200° C. In some embodiments, the heating 106 comprising heating at or to a temperature in a range of 20° C. to 190° C. In some embodiments, the heating 106 comprising heating at or to a temperature in a range of 20° C. to 180° C. In some embodiments, the heating 106 comprising heating at or to a temperature in a range of 20° C. to 170° C. In some embodiments, the heating 106 comprising heating at or to a temperature in a range of 20° C. to 160° C. In some embodiments, the heating 106 comprising heating at or to a temperature in a range of 20° C. to 150° C. In some embodiments, the heating 106 comprising heating at or to a temperature in a range of 20° C. to 140° C. In some embodiments, the heating 106 comprising heating at or to a temperature in a range of 20° C. to 130° C. In some embodiments, the heating 106 comprising heating at or to a temperature in a range of 20° C. to 120° C. In some embodiments, the heating 106 comprising heating at or to a temperature in a range of 20° C. to 110° C.

In some embodiments, the heating 106 comprising heating at or to a temperature in a range of 20° C. to 100° C. In some embodiments, the heating 106 comprising heating at or to a temperature in a range of 20° C. to 90° C. In some embodiments, the heating 106 comprising heating at or to a temperature in a range of 20° C. to 80° C. In some embodiments, the heating 106 comprising heating at or to a temperature in a range of 20° C. to 70° C. In some embodiments, the heating 106 comprising heating at or to a temperature in a range of 20° C. to 60° C. In some embodiments, the heating 106 comprising heating at or to a temperature in a range of 20° C. to 50° C. In some embodiments, the heating 106 comprising heating at or to a temperature in a range of 20° C. to 40° C. In some embodiments, the heating 106 comprising heating at or to a temperature in a range of 20° C. to 30° C.

In some embodiments, the method of installation 100 comprises curing 108 the water-curable silicone composition so as to obtain a water-cured silicone composition. In some embodiments, the curing 108 comprises reacting the polysiloxane and the crosslinker, so as to obtain a cured silicone composition. In some embodiments, the curing 108 comprises reacting the polysiloxane and the crosslinker, in a presence of the water activated catalyst, so as to obtain a cured silicone composition. In some embodiments, the curing 108 in the presence of the water-activated catalyst is sufficient to increase a reaction rate of the polysiloxane and the crosslinker. In some embodiments, the cured silicone composition comprises a crosslinked polysiloxane.

In some embodiments, the water obtained from the heat-activated water-release agent is sufficient to induce curing of the water-curable silicone composition at ambient conditions. In some embodiments, the water obtained from the heat-activated water-release agent is sufficient to fully cure the water-curable silicone composition at ambient conditions. In other words, in some embodiments, the water-curable silicone composition does not require an additional active step to induce curing and/or fully cure the water-curable silicone composition. For example, in some embodiments, the curing 108 does not comprise subjecting the water-curable silicone composition to an external stimuli. In some embodiments, the term “external stimuli” does not refer to stimuli present at ambient conditions in an environment (e.g., ambient temperature, ambient pressure, ambient exposure to natural light, etc.). In some embodiments, the external stimuli are different from the heating 106. In some embodiments, the term “external stimuli” does not refer to at least one of natural light, moisture present at ambient conditions, heating other than the heating 106, or any combination thereof. In some embodiments, the term “external stimuli” refers to a second light source, wherein the second light source is different from natural light. In some embodiments, the term “external stimuli” refers to a second water source, wherein the second water source is different from the water from the heat-activated water-release agent and/or water/moisture present at ambient conditions. In some embodiments, the term “external stimuli” refers to a second heat source, wherein the second heat source is different from ambient temperature and/or the heating 106. In some embodiments, the curing 108 proceeds without performing another active step after the heating 106.

Some embodiments relate to a system. In some embodiments, the system is a roofing system. In some embodiments, the system is a building envelope system. In some embodiments, the system is a membrane. In some embodiments, the system comprises a substrate. In some embodiments, the system comprises a cured silicone composition on the substrate. In some embodiments, the system comprises a cured silicone composition covering the substrate. In some embodiments, the system comprises a cured silicone composition impregnating (or pressed into) the substrate. In some embodiments, the system comprises a cured silicone composition directly contacting the substrate. In some embodiments, the system comprises a cured silicone composition adhered to the substrate. In some embodiments, the system comprises a cured silicone composition coating the substrate. In some embodiments, the system comprises a cured silicone composition bonded to the substrate. In some embodiments, the system comprises a cured silicone composition secured or fastened to the substrate. In some embodiments, the system comprises a cured silicone composition installed on the substrate. In some embodiments, the cured silicone composition is a silicone coating. In some embodiments, the cured silicone composition is a silicone membrane.

In some embodiments, the substrate comprises at least one of a mesh, a fabric, or any combination thereof. In some embodiments, the substrate is woven. In some embodiments, the substrate is nonwoven. In some embodiments, the substrate comprises a polyester fabric, a polyester mat, a fiberglass mat, a knit, a scrim, a fibrous support, synthetic fibers, or any combination thereof. In some embodiments, the substrate comprises, for example, at least one of glass, silica, metals, ceramic, silicon carbide, carbon, boron, basalt. In some embodiments, the synthetic fibers comprise at leas tone of polyesters, polyamides, polyacrylics, chlorofibres, polyolefins, synthetic rubbers, polyvinyl alcohol, aramides, phenolics, or any combination thereof.

In some embodiments, the substrate is a building structure. As used herein, the term “building structure” refers to any structural component of a building. For example, in some embodiments, a building structure comprises at least one of a parapet wall, a roof substrate, a roof deck, a skylight, a roof edge, a building wall, a roof penetration, rough openings such as a window frame and/or a door frame, a seam between walls and other structures, a pipe, a corner, an edge, an overhang, a coating, a framing, a through-hole in a wall, or any combination thereof. In some embodiments, a roof deck is a structure supporting a roof. In some embodiments, a roof substrate comprises at least one of a plywood substrate, a glass substrate, a cellulosic substrate, a roof shingle, a mat, a fabric, a glass mat, a fiberglass mat, an underlayment, a roofing membrane, a roof deck, a photovoltaic (PV) panel, a modified bitumen (MODBIT) substrate, a roll good, a board (such as but not limited to at least one of a foam board (e.g., a polyisocyanurate (ISO) foam board), a cover board, or any combination thereof), a pipe, a base sheet, a chimney, a wax paper, or any combination thereof. In some embodiments, a parapet wall is a barrier at an edge of a structure, such as, for example and without limitation, at least one of a roof, a terrace, a balcony, a walkway, or any combination thereof, and the like.

In some embodiments, the cured silicone composition comprises a crosslinked polysiloxane. In some embodiments, the cured silicone composition comprises at least one of the water-release agent or a derivative thereof (e.g., a thermal decomposed water-release agent, a dehydrated (waterless) water-release agent, or a residue of the water-release agent), the water-activated catalyst, unreacted crosslinker, the filler, the adhesion promoter, the pigment, the plasticizer, the reinforcing fiber, the wetting agent, the dispersant, the thickener (or the rheology modifier), the plasticizer, the surfactant, the compatibilizer, the dehydrating agent, the pH adjuster, the biocide, the processing aid, the antioxidant, the ageing inhibitor, the buffer, the antimicrobial agent, the solvent, or any combination thereof.

In some embodiments, the cured silicone composition has a thickness of 1 mil to 500 mils. In some embodiments, the cured silicone composition has a thickness of 25 mil to 500 mils. In some embodiments, the cured silicone composition has a thickness of 50 mil to 500 mils. In some embodiments, the cured silicone composition has a thickness of 75 mil to 500 mils. In some embodiments, the cured silicone composition has a thickness of 100 mil to 500 mils. In some embodiments, the cured silicone composition has a thickness of 125 mil to 500 mils. In some embodiments, the cured silicone composition has a thickness of 150 mil to 500 mils. In some embodiments, the cured silicone composition has a thickness of 175 mil to 500 mils. In some embodiments, the cured silicone composition has a thickness of 200 mil to 500 mils. In some embodiments, the cured silicone composition has a thickness of 225 mil to 500 mils. In some embodiments, the cured silicone composition has a thickness of 250 mil to 500 mils. In some embodiments, the cured silicone composition has a thickness of 275 mil to 500 mils. In some embodiments, the cured silicone composition has a thickness of 300 mil to 500 mils. In some embodiments, the cured silicone composition has a thickness of 325 mil to 500 mils. In some embodiments, the cured silicone composition has a thickness of 350 mil to 500 mils. In some embodiments, the cured silicone composition has a thickness of 375 mil to 500 mils. In some embodiments, the cured silicone composition has a thickness of 400 mil to 500 mils. In some embodiments, the cured silicone composition has a thickness of 425 mil to 500 mils. In some embodiments, the cured silicone composition has a thickness of 450 mil to 500 mils. In some embodiments, the cured silicone composition has a thickness of 475 mil to 500 mils.

In some embodiments, the cured silicone composition has a thickness of 1 mil to 25 mils. In some embodiments, the cured silicone composition has a thickness of 1 mil to 50 mils. In some embodiments, the cured silicone composition has a thickness of 1 mil to 75 mils. In some embodiments, the cured silicone composition has a thickness of 1 mil to 100 mils. In some embodiments, the cured silicone composition has a thickness of 1 mil to 125 mils. In some embodiments, the cured silicone composition has a thickness of 1 mil to 150 mils. In some embodiments, the cured silicone composition has a thickness of 1 mil to 175 mils. In some embodiments, the cured silicone composition has a thickness of 1 mil to 200 mils. In some embodiments, the cured silicone composition has a thickness of 1 mil to 225 mils. In some embodiments, the cured silicone composition has a thickness of 1 mil to 250 mils. In some embodiments, the cured silicone composition has a thickness of 1 mil to 275 mils. In some embodiments, the cured silicone composition has a thickness of 1 mil to 300 mils. In some embodiments, the cured silicone composition has a thickness of 1 mil to 325 mils. In some embodiments, the cured silicone composition has a thickness of 1 mil to 350 mils. In some embodiments, the cured silicone composition has a thickness of 1 mil to 375 mils. In some embodiments, the cured silicone composition has a thickness of 1 mil to 400 mils. In some embodiments, the cured silicone composition has a thickness of 1 mil to 425 mils. In some embodiments, the cured silicone composition has a thickness of 1 mil to 450 mils. In some embodiments, the cured silicone composition has a thickness of 1 mil to 475 mils.

In some embodiments, the system has a thickness of 1 mil to 500 mils. In some embodiments, the system has a thickness of 25 mil to 500 mils. In some embodiments, the system has a thickness of 50 mil to 500 mils. In some embodiments, the system has a thickness of 75 mil to 500 mils. In some embodiments, the system has a thickness of 100 mil to 500 mils. In some embodiments, the system has a thickness of 125 mil to 500 mils. In some embodiments, the system has a thickness of 150 mil to 500 mils. In some embodiments, the system has a thickness of 175 mil to 500 mils. In some embodiments, the system has a thickness of 200 mil to 500 mils. In some embodiments, the system has a thickness of 225 mil to 500 mils. In some embodiments, the system has a thickness of 250 mil to 500 mils. In some embodiments, the system has a thickness of 275 mil to 500 mils. In some embodiments, the system has a thickness of 300 mil to 500 mils. In some embodiments, the system has a thickness of 325 mil to 500 mils. In some embodiments, the system has a thickness of 350 mil to 500 mils. In some embodiments, the system has a thickness of 375 mil to 500 mils. In some embodiments, the system has a thickness of 400 mil to 500 mils. In some embodiments, the system has a thickness of 425 mil to 500 mils. In some embodiments, the system has a thickness of 450 mil to 500 mils. In some embodiments, the system has a thickness of 475 mil to 500 mils.

In some embodiments, the system has a thickness of 1 mil to 25 mils. In some embodiments, the system has a thickness of 1 mil to 50 mils. In some embodiments, the system has a thickness of 1 mil to 75 mils. In some embodiments, the system has a thickness of 1 mil to 100 mils. In some embodiments, the system has a thickness of 1 mil to 125 mils. In some embodiments, the system has a thickness of 1 mil to 150 mils. In some embodiments, the system has a thickness of 1 mil to 175 mils. In some embodiments, the system has a thickness of 1 mil to 200 mils. In some embodiments, the system has a thickness of 1 mil to 225 mils. In some embodiments, the system has a thickness of 1 mil to 250 mils. In some embodiments, the system has a thickness of 1 mil to 275 mils. In some embodiments, the system has a thickness of 1 mil to 300 mils. In some embodiments, the system has a thickness of 1 mil to 325 mils. In some embodiments, the system has a thickness of 1 mil to 350 mils. In some embodiments, the system has a thickness of 1 mil to 375 mils. In some embodiments, the system has a thickness of 1 mil to 400 mils. In some embodiments, the system has a thickness of 1 mil to 425 mils. In some embodiments, the system has a thickness of 1 mil to 450 mils. In some embodiments, the system has a thickness of 1 mil to 475 mils.

### Example 1

A silicone composition is prepared. The silicone composition comprises a silanol-terminated polysiloxane, a crosslinker, a water-activated catalyst, and a heat-activated water-release agent. The heat-activated water-release agent is a hydrated zeolite filler. The hydrated zeolite filler is present in an amount of 1% to 50% by weight based on a total weight of the silicone composition. To obtain the hydrated zeolite filler, a zeolite filler is pre-saturated with water. The silicone composition is cast into a film and heated to a temperature sufficient to release water from the zeolite filler. The water released from the zeolite filler is sufficient to activate the water-activated catalyst and induce curing of the silanol-terminated polysiloxane and the crosslinker to obtain a cured silicone composition.

### Example 2

A silicone composition is prepared. The silicone composition comprises a silanol-terminated polysiloxane, a crosslinker, a water-activated catalyst, and a heat-activated water-release agent. The heat-activated water-release agent is a hydrated sodium sulfate (Na₂SO₄·7H₂O). The hydrated sodium sulfate is present in an amount of 0.5% to 10% by weight based on a total weight of the silicone composition. The silicone composition is cast into a film and heated to a temperature sufficient to release water from the hydrated sodium sulfate. The water released from the hydrated sodium sulfate is sufficient to activate the water-activated catalyst and induce curing of the silanol-terminated polysiloxane and the crosslinker to obtain a cured silicone composition.

### Example 3

A silicone composition is prepared. The silicone composition comprises a silanol-terminated polysiloxane, a crosslinker, a water-activated catalyst, and a heat-activated water-release agent. The heat-activated water-release agent is a sodium bicarbonate. The sodium bicarbonate is present in an amount of 0.5% to 10% by weight based on a total weight of the silicone composition. The silicone composition is cast into a film and heated at or to a temperature (e.g., 100° C.) sufficient for the sodium bicarbonate to decompose into CO₂ and H₂O, thereby producing water. The water produced by decomposition of the sodium bicarbonate is sufficient to activate the water-activated catalyst and induce curing of the silanol-terminated polysiloxane and the crosslinker to obtain a cured silicone composition. In addition, the CO₂ generated by decomposition of the sodium bicarbonate acts as a blowing agent useful in making the cured silicone coating porous like a sponge.

### Example 4

A silicone composition is prepared. The silicone composition comprises a silanol-terminated polysiloxane, a crosslinker, a water-activated catalyst, and a heat-activated water-release agent. The heat-activated water-release agent is a sodium dihydrogen phosphate. The sodium dihydrogen phosphate is present in an amount of 0.5% to 10% by weight based on a total weight of the silicone composition. The silicone composition is cast into a film and heated at or to a temperature (e.g., 180° C.) sufficient for the sodium dihydrogen phosphate to decompose into CO₂ and H₂O, thereby producing water. The water produced by decomposition of the sodium dihydrogen phosphate is sufficient to activate the water-activated catalyst and induce curing of the silanol-terminated polysiloxane and the crosslinker to obtain a cured silicone composition. In addition, the CO₂ generated by decomposition of the sodium dihydrogen phosphate acts as a blowing agent useful in making the cured silicone coating porous like a sponge.

### Example 5

A silicone composition is prepared. The silicone composition comprises a silanol-terminated polysiloxane, a crosslinker, a water-activated catalyst, and a heat-activated water-release agent. The heat-activated water-release agent is an aluminum trihydrate. The aluminum trihydrate is present in an amount of 0.5% to 30% by weight based on a total weight of the silicone composition. The silicone composition is cast into a film and heated at or to a temperature (e.g., 200° C.) sufficient for the aluminum trihydrate to decompose and produce H₂O. The water produced by decomposition of the aluminum trihydrate is sufficient to activate the water-activated catalyst and induce curing of the silanol-terminated polysiloxane and the crosslinker to obtain a cured silicone composition.

What is claimed is:

1. A method of installation comprising:
obtaining a water-curable silicone composition,
wherein the water-curable silicone composition comprises:
a silanol-terminated polysiloxane;
a crosslinker;
a water-activated catalyst; and
1% to 40% by weight of a heat-activated water-release agent based on a total weight of the water-curable silicone composition;
applying the water-curable silicone composition to at least one surface of a building structure;
heating the water-curable silicone composition to a temperature of 250° C. or less, so as to obtain a water from the heat-activated water-release agent,
wherein the water obtained from the heat-activated water-release agent activates the water-activated catalyst; and
curing the water-curable silicone composition, so as to obtain a water-cured silicone composition.

2. The method of claim 1, wherein the water-curable silicone composition is heated to a temperature of 20° C. to 250° C.

3. The method of claim 1, wherein the heating decomposes the heat-activated water-release agent, so as to obtain the water.

4. The method of claim 1, wherein the heating disassociates water molecules from the heat-activated water-release agent, so as to obtain the water.

5. The method of claim 1, wherein the curing comprises reacting the silanol-terminated polysiloxane and the crosslinker in a presence of the water-activated catalyst.

6. The method of claim 1, wherein the water-curable silicone composition further comprises:
at least one filler,
wherein the at least one filler is different from the heat-activated water-release agent.

7. The method of claim 6, wherein the water-curable silicone composition comprises:
10% to 80% by weight of the silanol-terminated polysiloxane based on the total weight of the water-curable silicone composition;
1% to 30% by weight of the crosslinker based on the total weight of the water-curable silicone composition;
0.1% to 20% by weight of the water-activated catalyst based on the total weight of the water-curable silicone composition; and
1% to 50% by weight of at least one filler based on the total weight of the water-curable silicone composition.

8. The method of claim 7, wherein the water-curable silicone composition comprises 1% to 30% by weight of the heat-activated water-release agent based on the total weight of the water-curable silicone composition.

9. The method of claim 1, wherein the heat-activated water-release agent comprises at least one of an inorganic hydrate compound, an organic hydrate compound, or any combination thereof.

10. The method of claim 1, wherein the heat-activated water-release agent comprises a compound that decomposes to produce the water in response to the heating.

11. A water-curable silicone composition comprising:
a silanol-terminated polysiloxane;
a crosslinker;
a water-activated catalyst; and
a heat-activated water-release agent,
wherein the heat-activated water-release agent is present in the water-curable silicone composition in an amount sufficient to obtain, in response to heating, a water for activating the water-activated catalyst,
wherein the water-activated catalyst is selected from the group consisting of catalysts for inducing, in a presence of the water obtained from the heat-activated water-release agent, curing of the water-curable silicone composition,
wherein the heat-activated water-release agent comprises at least one of an inorganic hydrate compound, an organic hydrate compound, or any combination thereof.

12. The water-curable silicone composition of claim 11, wherein the water-curable silicone composition comprises 10% to 80% by weight of the silanol-terminated polysiloxane based on a total weight of the water-curable silicone composition.

13. The water-curable silicone composition of claim 11, wherein the water-curable silicone composition comprises 1% to 30% by weight of the crosslinker based on a total weight of the water-curable silicone composition.

14. The water-curable silicone composition of claim 11, wherein the water-curable silicone composition comprises 0.1% to 20% by weight of the water-activated catalyst based on a total weight of the water-curable silicone composition.

15. The water-curable silicone composition of claim 11, wherein the water-curable silicone composition comprises 1% to 40% by weight of the heat-activated water-release agent based on a total weight of the water-curable silicone composition.

16. The water-curable silicone composition of claim 11, further comprising:
at least one filler,
wherein the at least one filler is different from the heat-activated water-release agent.

17. The water-curable silicone composition of claim 16, wherein the water-curable silicone composition comprises 1% to 50% by weight of the at least one filler based on a total weight of the water-curable silicone composition.

18. The water-curable silicone composition of claim 16, wherein the water-curable silicone composition comprises:
10% to 80% by weight of the silanol-terminated polysiloxane based on a total weight of the water-curable silicone composition;
1% to 30% by weight of the crosslinker based on the total weight of the water-curable silicone composition;
0.1% to 20% by weight of the water-activated catalyst based on the total weight of the water-curable silicone composition; and
1% to 50% by weight of at least one filler based on the total weight of the water-curable silicone composition.

19. The water-curable silicone composition of claim 11, wherein the heat-activated water-release agent comprises the inorganic hydrate compound.

20. The water-curable silicone composition of claim 11, wherein the heat-activated water-release agent comprises the organic hydrate compound.
